(19) United States
(12) Patent Application Publication
(10) Pub. No.: US 2012/0085134 A1
(43) Pub. Date: Apr. 12, 2012

(54) ADJUSTABLE CABLE SECURITY DEVICE

(75) Inventors: Mark Ezzo, Tyler, TX (US); Matthew R. Shute, Charlotte, NC (US)

(73) Assignee: CHECKPOINT SYSTEMS INC., Thorofare, NJ (US)

(21) Appl. No.: 13/252,894

(22) Filed: Oct. 4, 2011

Related U.S. Application Data
(60) Provisional application No. 61/389,538, filed on Oct. 4, 2010.
(60) Provisional application No. 61/421,883, filed on Dec. 10, 2010.

(51) Int. Cl. E05B 73/00; E05B 45/06

(52) U.S. Cl. 70/15

(57) ABSTRACT

A security device is provided herein, the security device being structured for secure attachment to an object. The security device which comprises a housing, locking assembly, and cable, may also carry an alarm system for increased security. The locking assembly locks the cable at a desired length to secure an object. In one embodiment, a ratchet mechanism uses a spool that collects the cable when the ratchet is rotated, such that the cable tightens around the object to secure it. The ratchet mechanism, even when locked, still allows the cable to be tightened. In other embodiments of the security device a slide grip or pressing feature can be moved or pushed to engage a clamp feature, thereby pinching the cable in place. The cable may be comprised of two separate cables combined with sheathing for increased protection and insulation.

### CROSS-REFERENCE TO RELATED APPLICATION

This patent application claims priority from U.S. Provisional Application No. 61/389,538, filed Oct. 4, 2010, entitled “Adjustable Cable Security Device,” and U.S. Provisional Application No. 61/421,883, filed Dec. 10, 2010, entitled “Adjustable Cable Security Device,” which are hereby incorporated by reference in their entireties.

### FIELD OF THE INVENTION

Embodiments discussed herein are related to a security device structured for attachment to an object. Such security devices often employ or form part of electronic article surveillance (EAS) systems that deter and detect shoplifting.

### BACKGROUND OF THE INVENTION

Deterring and preventing product theft is important in retail environments. Balancing a desire for robust presentation and accessibility of retail products with proper security can be difficult. The development and wide-spread implementation of electronic article surveillance (“EAS”) systems have helped deter retail theft while maintaining display options for retail products. Tags or other security elements, e.g., radio frequency identification (“RFID”) transponders, can be placed on or associated with retail products to trigger ant-theft or anti-tampering alarms.

Applicant has identified a number of deficiencies and problems associated with the manufacture, use, design, and operation of conventional security devices. Through applied effort, ingenuity, and innovation, Applicant has solved many of these identified problems by developing a solution that is embodied by the present invention, which is described in detail below.

### SUMMARY OF THE INVENTION

It is desirable to protect retail products or articles from theft, tampering or to provide benefit denial functionality (e.g., rendering the article unusable after a theft or tampering event). Such protection may be afforded by security devices that carry a security element (e.g., an EAS or RFID tag) and that are configured to securely attach to the retail article. Depending on the structure of the article, it may be difficult or cumbersome to attach the security device to the article.

Various embodiments of the present invention are directed to improved security devices, and methods for making the same, which are configured to provide secure and repeatable attachment to retail articles of differing sizes, shapes, and structures. In some embodiments, this attachment flexibility is afforded by the adjustability of the security devices discussed herein.

In an example embodiment, a security device for secure attachment to an object is provided. The security device comprises a cable defining an anchor end and a removable end, and a housing configured to removably receive the removable end of the cable and securely support the anchor end of the cable. The housing defines a cavity structured to receive the removable end of the cable along a first direction. The security device further comprises a securing member supported by the housing that is drivable by a user from a release position along a slide direction to a capture position. The cable is secured within the cavity in the capture position and releasable from the cavity in the release position.

In some embodiments, the securing member may be biased toward the release position and the security device may further comprise a cam configured to slidably engage the securing member. The user may move the cam against the securing member to drive the securing member against the bias and toward the capture position.

In some embodiments, the security device may further comprise a locking feature configured to engage the cam to prevent movement of the cam in a locked position and to allow movement of the cam in an unlocked position. Additionally, the locking feature may be biased toward the locked position. In some embodiments, at least a portion of the locking feature may comprise a ferrous material such that the locking feature is configured to be moved to the unlocked position upon application of a magnetic field. In some embodiments, the security device further comprises a security element.

In some embodiments, the securing member may be drivable by the user to engage the cable at a first engagement position along the cable length, thereby defining a first cable loop length, or a second engagement position along the cable length, thereby defining a second cable loop length that is larger than the first cable loop length. Additionally or alternatively, the security device may further comprise a capture angle defined between the first direction and the slide direction, wherein the capture angle is between approximately 30 degrees and approximately 150 degrees. In some embodiments, the capture angle is approximately 90 degrees.

In another example embodiment, a security device for secure attachment to an object is provided. The security device comprises a cable defining an anchor end and a removable end, and a housing defining a cavity structured to receive the removable end of the cable. The security device further comprises a spool assembly rotatably supported by the housing. The spool assembly is configured to secure the anchor end of the cable, take-up the cable when rotated in a winding direction, and payout the cable when rotated in a unwinding direction. The security device further comprises a securing member movable along a slide direction between a capture position and a release position. The securing member is configured to secure the spool assembly to prevent rotation in the unwinding direction when disposed in the capture position.

In some embodiments, the securing member may be biased toward the release position and the removable end of the cable may define a cam that is configured to slideably engage the securing member to force the securing member against the bias and toward the capture position when the removable end of the cable is inserted into the cavity. Additionally, the security device may further comprise a locking feature configured to engage the cam to prevent removal of the cam from the cavity. In some embodiments, the security device may further comprise a security element.

In some embodiments, the spool assembly may further define a grip portion configured for engagement by a user to rotate the spool assembly. Additionally or alternatively, the spool assembly further defines a ratchet portion. In some embodiments, the securing member may comprise at least one locking tooth configured to engage receiving teeth defined by the ratchet portion. The at least one locking tooth may be tapered to allow rotation of the spool assembly in the winding direction and to prevent rotation in the unwinding direction when the securing member is disposed in the capture position.

In another example embodiment, a security device for secure attachment to an object is provided. The security device comprises a cable defining an anchor end and a removable end, and a housing configured to secure the anchor end of the cable and configured to removably receive the removable end of the cable. The housing defines a cavity structured to receive the removable end of the cable along a first direction. The security device further comprises a securing member supported by the housing that is drivable by a user from a release position to a capture position. The cable is secured within the cavity by the securing member in the capture position and releasable from the cavity in the release position.

In some embodiments, the securing member may be drivable by the user to engage the cable at a first engagement position along the cable length, thereby defining a first cable loop length, or a second engagement position along the cable length, thereby defining a second cable loop length that is larger than the first cable loop length. Additionally or alternatively, the securing member may be drivable by the user from the release position along a slide direction to the capture position. A capture angle may be defined between the first direction and the slide direction, and may be between approximately 30 degrees and approximately 150 degrees. In some embodiments, the capture angle is approximately 90 degrees.

In some embodiments, the securing member may be biased toward the release position and the security device may further comprise a cam configured to slidably engage the securing member. The user may move the cam against the securing member to drive the securing member against the bias and toward the capture position. In some embodiments, the cam defines a grip accessible through the housing and configured for engagement by the user to move the cam. Additionally, the security device may further comprise a locking feature configured to engage the cam to prevent movement of the cam when the securing member is disposed in the capture position. In some embodiments, the security device may further comprise a security element.

In some embodiments, the securing member may define at least two teeth structured to crimp the cable when the securing member is disposed in the capture position.

In some embodiments, the security device may further comprise a second securing member that is drivable by the user from a second release position to a second capture position. The cable may be positioned between the second securing member and the securing member, and the user may move the cam against the securing member and the second securing member to drive the securing member and the second securing member to the capture position and the second capture position respectively.

In other embodiments, the security device is rotatably supported within the housing and the securing member may be driven by the user to rotate from the release position to the capture position.

In some embodiments, the housing may define first and second ends. The cavity may be defined by the housing between the first and second ends such that the removable end of the cable may be inserted into the cavity proximate the first end and pass fully through the housing to at least partially protrude from the housing proximate the second end.

In yet another example embodiment, a security device for secure attachment to an object is provided. The security device comprises a cable defining an anchor end and a removable end, and a housing configured to secure the anchor end of the cable and configured to removably receive the removable end of the cable. The housing defines a cavity structured to receive the removable end of the cable along a first direction. The security device further comprises opposing first and second securing members that are drivable by a user from a release position to a capture position. The cable is secured within the cavity by the opposing first and second securing members in the capture position and releasable from the cavity in the release position.

In some embodiments, the opposing first and second securing members may be biased toward the release position. The security device may further comprise a slide, and wherein movement of the slide by the user operates to drive the opposing first and second securing members from the release position to the capture position. Additionally, the slide may engage the opposing first and second securing members to drive the opposing first and second securing members from the release position to the capture position. In some embodiments, the slide indirectly engages the opposing first and second securing members to drive the opposing first and second securing members from the release position to the capture position.

In some embodiments, the security device may further comprise a driven element, wherein movement of the slide by the user operates to move the driven element, which directly engages the opposing first and second securing members. Additionally, the security device may further comprise a biasing element disposed between the driven element and the slide.

In another example embodiment, a security device for secure attachment to an object is provided. The security device comprises a cable defining an anchor end and a removable end, and a housing configured to secure the anchor end of the cable and configured to removably receive the removable end of the cable. The housing defines a housing cavity structured to receive the removable end of the cable along a first direction. The security device further comprises an annular lock housing supported by the housing, wherein the annular lock housing defines a shoulder portion. The security device also comprises an annular shuttle slidably supported proximate the lock housing. The annular shuttle defines a shuttle cavity aligned with the housing cavity so as to receive the removable end of the cable upon insertion into the cavity. The annular shuttle supports opposing first and second securing members that are drivable from a release position in which the cable may be removed from the shuttle cavity and a capture position in which the cable is secured within the shuttle cavity. Movement of the annular shuttle relative to the annular lock housing causes the opposing first and second securing members to engage the shoulder portion of the annular lock housing thereby driving the opposing first and second securing members to the capture position.

In some embodiments, the annular shuttle may be biased to position the opposing first and second securing members in the release position and the security device may further comprise a slide. Movement of the slide by the user may operate to move the annular shuttle and drive the opposing first and second securing members from the release position to the capture position.

In some embodiments, the security device may further comprise a locking feature configured to engage the slide to prevent movement of the slide when the opposing first and second securing members are in the capture position. Additionally, the locking feature may be configured to secure the opposing first and second securing members in the capture position. In some embodiments, the locking feature engages the slide to prevent movement of the slide. In some embodiments, the security device may comprise a security element.

In some embodiments, the security device may further comprise a first biasing element disposed proximate a first side of the annular shuttle, and a second biasing element disposed proximate the second side of the annular shuttle between the annular shuttle and the slide. The first biasing element may be structured to produce a greater biasing force than the second biasing element.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a security device structured in accordance with embodiments discussed herein;

FIG. 2 is a detail, partially sectioned, view of the security device shown in FIG. 1 disposed in an unlocked configuration, in accordance with embodiments discussed herein;

FIG. 2A is a detail, partially sectioned, view of another embodiment of the security device shown in FIG. 1 disposed in an unlocked configuration, in accordance with embodiments discussed herein;

FIG. 3 is a detail, partially sectioned, view of the security device shown in FIG. 1 disposed in a locked configuration, in accordance with embodiments discussed herein;

FIG. 4 is a perspective view of a ratchet mechanism of the security device shown in FIG. 1, in accordance with embodiments discussed herein;

FIG. 5 is a perspective view of a ratchet mechanism partially receiving a cable for use in a security device structured in accordance with embodiments discussed herein;

FIG. 5A is a detail view of the cable of FIG. 5, which is structured in accordance with embodiments discussed herein;

FIG. 6 is a perspective view of the security device of FIG. 1 disposed in a locked configuration, wherein the security device is configured to receive a magnetic key in accordance with embodiments discussed herein;

FIG. 7 is a perspective view of the security device shown in FIG. 1 disposed in an unlocked configuration in accordance with embodiments discussed herein;

FIG. 8 is a partially sectioned view of the security device shown in FIG. 1 illustrating a security element (i.e., electronic article surveillance components) in accordance with embodiments discussed herein;

FIG. 9 is a perspective view of a security device having a thumb lock structured in accordance with embodiments discussed herein;

FIG. 10 is a perspective view of the security device shown in FIG. 9, wherein the cable is partially removed from the housing of the security device in accordance with embodiments discussed herein;

FIG. 11 is a rear perspective view of the security device shown in FIG. 9, wherein the cable is inserted into and through the housing of the security device in accordance with embodiments discussed herein;

FIG. 12 is a detail, partially transparent, view of the security device shown in FIG. 9, wherein the security device is disposed in an unlocked configuration in accordance with embodiments discussed herein;

FIG. 13 is a detail, partially sectioned, view of the security device shown in FIG. 9, wherein the security device is disposed in an unlocked configuration in accordance with embodiments discussed herein;

FIG. 13A is a detail, partially sectioned, view of a security device structured in accordance with another embodiment;

FIG. 14 is a detail, partially sectioned, view of the security device shown in FIG. 9, wherein the security device is disposed in a locked configuration in accordance with embodiments discussed herein;

FIG. 14A is a detail view of a cable of the security device shown in FIG. 9, wherein the cable includes sheathing in accordance with embodiments discussed herein;

FIG. 15 is a perspective view of the security device shown in FIG. 9 disposed in a locked configuration, wherein the security device is adapted to be unlocked by a magnetic key in accordance with some embodiments discussed herein;

FIG. 16 is a perspective view of the security device shown in FIG. 9 and a magnetic key, wherein the security device is unlocked and the cable is partially removed from the housing of the security device, in accordance with some embodiments discussed herein;

FIG. 17 is a partially sectioned view of the security device shown in FIG. 9 illustrating electronic article surveillance components in accordance with embodiments discussed herein;

FIG. 18 is a partially sectioned view of a security device having a thumb slide type locking assembly structured in accordance with embodiments discussed herein;

FIG. 19 is a partially sectioned view of a security device having a thumb slide type locking assembly structured in accordance with embodiments discussed herein;

FIG. 20 is a partially sectioned view of a security device having a thumb slide and linkage type locking assembly structured in accordance with embodiments discussed herein;

FIG. 21 is a partially sectioned view of a security device having a thumb slide with a floating ball bearing-type locking assembly, wherein the security device is unlocked, structured in accordance with another embodiment of the invention;

FIG. 21A is a partially sectioned view of a security device having a thumb slide with a floating ball bearing-type locking assembly, wherein the security device is locked, structured in accordance with another embodiment of the invention;

FIG. 21B is a partially sectioned view of a security device having a thumb slide with a floating crimp feature-type locking assembly, wherein the security device is locked, structured in accordance with a another embodiment of the invention;

FIG. 22 is a partially sectioned view of a security device having a pressing feature and cam type locking assembly structured in accordance with embodiments discussed herein;

FIG. 23 is a partially sectioned view of a security device having a pressing feature and cam type locking assembly structured in accordance with embodiments discussed herein;

FIG. 24 is a partially sectioned view of a security device having a pressing feature and slide type locking assembly structured in accordance with embodiments discussed herein; and

FIG. 25 is a partially sectioned view of a security device having a pressing feature and slide type locking assembly structured in accordance with embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention provide a security device. The security device may be configured to secure to articles of merchandise or other objects and to prevent the unauthorized removal of or tampering with the security device. The security device may further include one or more alarm features. Moreover, the security device according to embodiments of the present invention may also provide other features or functionalities that a retail operator may prefer or consider prior to the use or selection of a particular security device over others. For example, while the security device is configured to prevent unauthorized removal from an object, the ease at which an authorized operator, such as an employee, can affect authorized removal of the security device from an object may be factor weighing in favor of selecting one security device over another. Similarly, the ease at which the security device can be secured to the merchandise may also be factor. Yet another factor may be the overall size or shape of the security device and the relative adjustability, or lack thereof, of the security device for attachment to objects of differing sizes and shapes. As explained in detail below, embodiments of the present invention provide a security device that may address one or more of the above features and functionality.

### Spool Embodiment

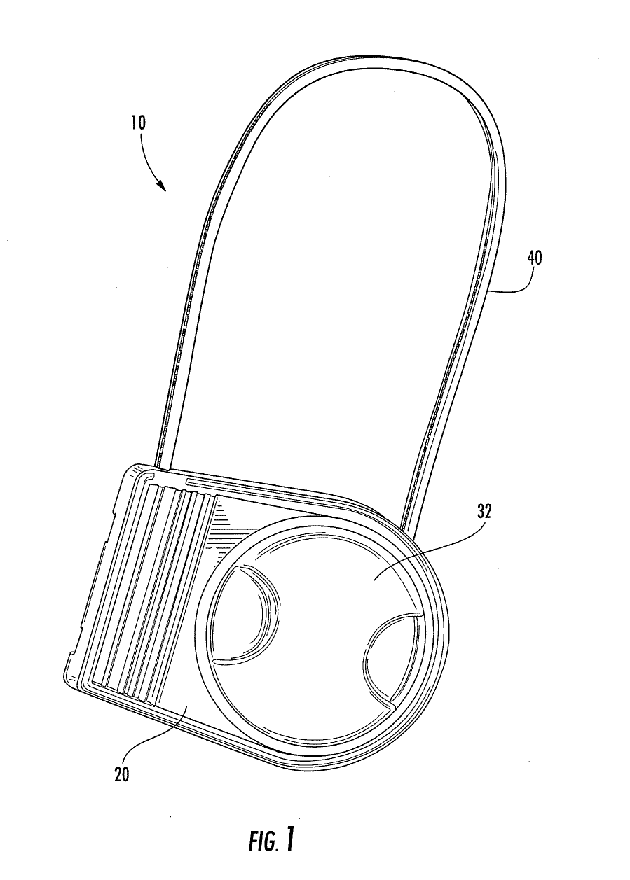

FIG. 1 shows one example embodiment of a security device configured for secure attachment to an object. The security device 10 shown in FIG. 1 may be referred to as a “spool type cable lock,” and may comprise a cable configured for tightening around an object such as a retail product (not shown). In the depicted embodiment, the security device 10 comprises a housing 20 and a cable 40. The cable 40 is structured to connect to the housing 20 at two different points so as to form a loop, which can be placed around the object or threaded through apertures defined in the object. A spin cap 32 protrudes through the housing 20 allowing a means for user initiated tightening of the cable 40 as will be discussed in greater detail below.

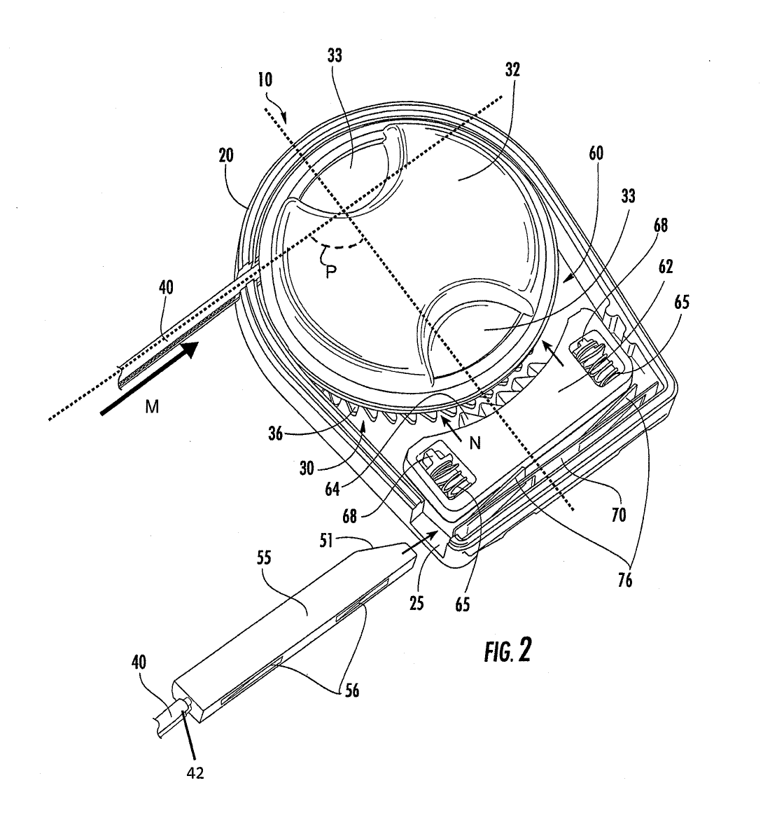

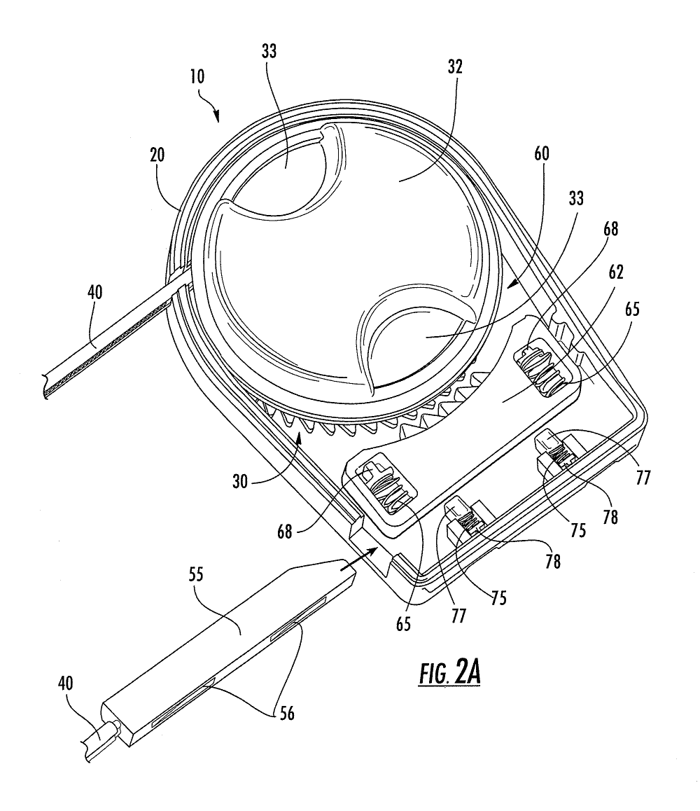

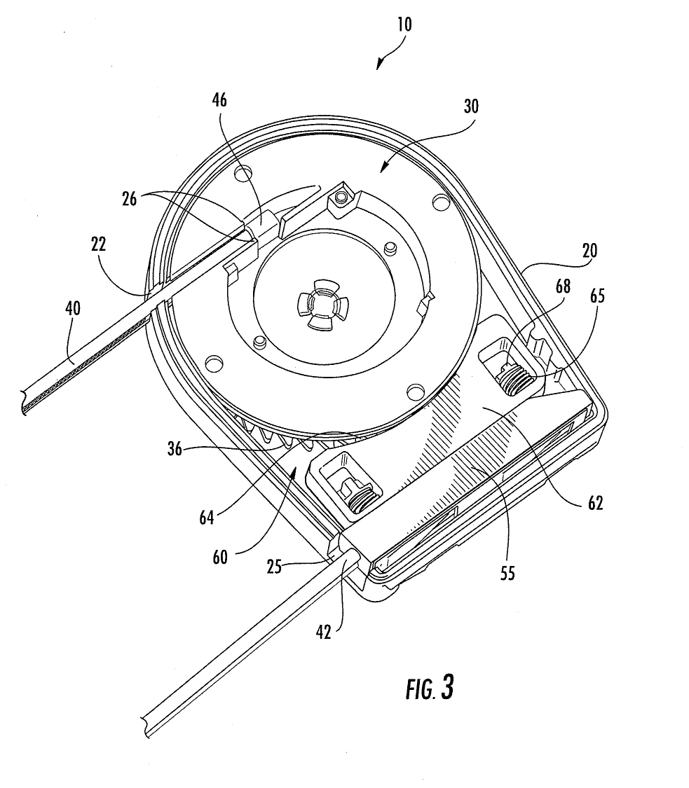

The security device 10 may comprise a cable defining an anchor end and a removable end. With reference to FIGS. 2, 2A, and 3, the cable 40 may comprise a spool end 46 (e.g., anchor end) and a lock end 42 (e.g., removable end).

The housing may be configured to securely support the anchor end of the cable within the housing. For example, the spool end 46 of the cable 40 may be anchored securely to a ratchet mechanism 30, which may be rotatably supported inside the housing 20 (shown in FIG. 3). In some embodiments, the spool end 46 of the cable 40 may have a cap or otherwise define a larger diameter than the rest of the cable 40 such that it may be readily captured within the ratchet mechanism 30.

The depicted ratchet mechanism 30 defines shoulders 26 for capturing the spool end 46 of the cable 40. In another embodiment, the spool end 46 of the cable 40 may be anchored to the housing 20 rather than the ratchet mechanism 30 in a manner that allows the cable 40 to be wound about the ratchet mechanism 30 as will be discussed in greater detail below.

In some embodiments, the housing may be configured to removably receive the removable end of the cable. In the depicted embodiment, the lock end 42 of the cable 40 is attached to, or otherwise ensleeved by, a cam 55. With reference to FIGS. 2, 2A, and 3, the cam 55 and, thus, the lock end 42 of the cable 40 may be removably received within the housing 20, such as within cavity 25.

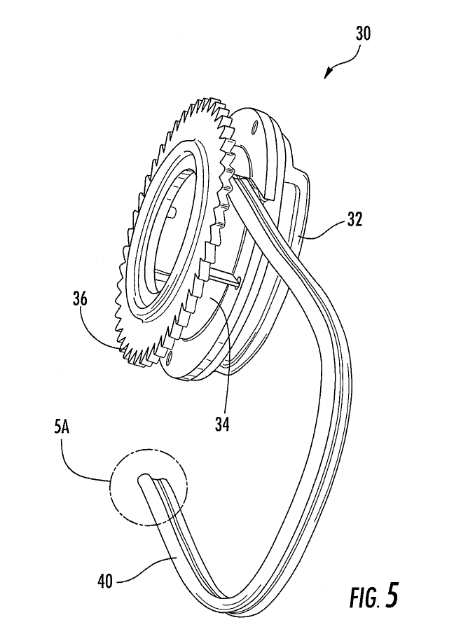

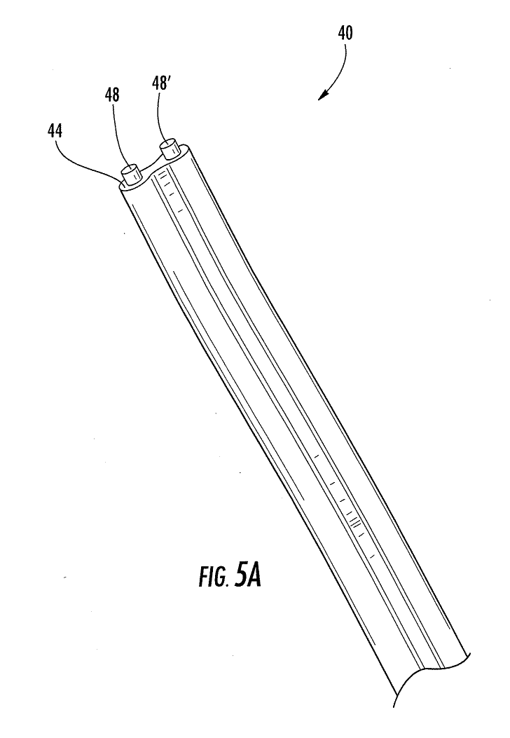

In one embodiment, the cable 40 of the security device 10 may be configured with a sheathing 44 as shown in FIG. 5A. The depicted cable 40 comprises two discrete cables 48, 48′. These cables 48, 48′ may be surrounded and held together by the sheathing 44 which may act as insulation in circumstances where electrical current is run through the cable 40. The sheathing 44 may also provide protection from cable abrasion or other damage to the object around which the cable 40 may be wrapped. As will be apparent to one of ordinary skill in the art, depending upon the application, a variety of other cable or cable-like structures could be used in connection with security devices of the type described herein such as, for example, ribbons, cords, wires, zip-tie type structures, and the like.

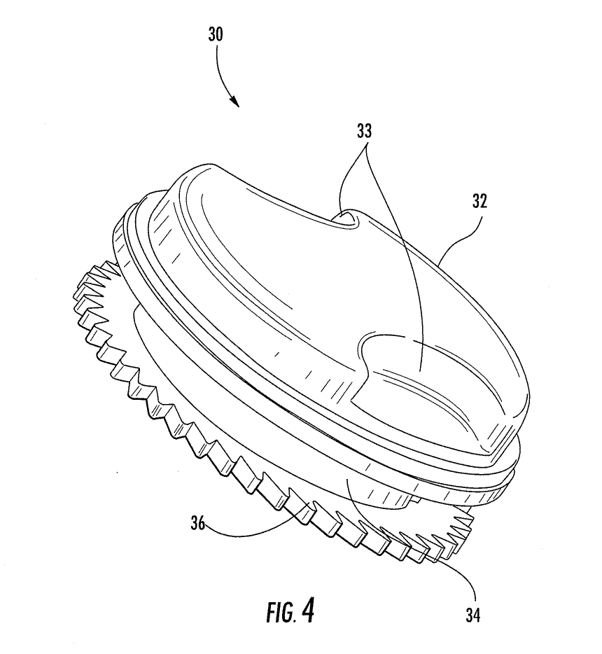

The cable of the security device may be configured to extend at least partially into the housing in a first direction. For example, with reference to FIG. 4, the security device 10 may comprise a ratchet mechanism 30 (e.g., spool assembly) rotatably supported by the housing and structured to take-up the spool end 46 of the cable within the housing 20 when rotated in a winding direction. The ratchet mechanism 30 may also be structured to pay-out the spool end 46 of the cable when rotated in an unwinding direction. The depicted ratchet mechanism 30 comprises a spin cap 32, engaging teeth 36, and a spool 34. The spin cap 32 is configured for grasping by a user thereby allowing a user to rotate the ratchet mechanism 30 to tighten the cable 40 around the object as desired. As was shown in FIG. 1, the spin cap 32 can protrude through the housing 20 to facilitate user access and may further define a grip portion (e.g., engagement features 33 that facilitate a better grip for the user). In the depicted embodiment, the engagement features 33 are impressions in the spin cap 32 that can be shaped so as to fit a thumb and pointer finger of a user. In other embodiments, the engagement features 33 can be protrusions, tabs, or other features that allow a user to readily rotate the spin cap 32.

In some embodiments, the ratchet mechanism 30 may be configured to take-up the spool end 46 of the cable in a first direction relative to the housing. For example, FIG. 3 shows that the spool end 46 of the cable 40 can be anchored in the ratchet assembly 30, however, the cable 40 can still thread through the housing 20 in a first direction (e.g., along arrow M shown in FIG. 2) by way of a cavity (e.g., cable hole 22), which is large enough to allow the cable 40 to move in and out of the housing 20 freely. Thus, with reference to FIG. 5, when the spin cap 32 is rotated, the cable 40 winds around the spool 34 thereby collecting the cable 40 onto the spool 34 and reducing the size of the u-shaped loop defined by the cable 40.

The security device may comprise a securing member supported by the housing and movable along a slide direction between a capture position and a release position. In some embodiments, the securing member is configured to secure the cable to prevent removal of the cable from the housing when disposed in the capture position. Additionally, in some embodiments, the securing member is drivable by a user from the release position along the slide direction to a capture position. For example, the security device may comprise a securing member (e.g., lock slide 62) defining a ratchet engaging surface having teeth 64 that are adapted to engage corresponding teeth 36 of the ratchet mechanism 30 when the lock slide 62 is disposed in the capture position (shown in FIG. 3). The lock slide 62 is configured to translate or slide along a slide direction (e.g., along arrows N shown in FIG. 2) either toward the locking plate 70 (e.g., when moving to the release position) or toward the ratchet mechanism 30 (e.g., when moving to the capture position).

As such, with reference to FIG. 2, the slide direction (e.g., along arrows N) may form a capture angle E relative to the first direction of the cable (e.g., along arrow M). In the depicted embodiment, the capture angle P defines approximately a 90° angle. In some embodiments, the capture angle may define a different angle (e.g., any angle from approximately 30° to approximately 150°).

In various embodiments, the cable is secured within the cavity (e.g., cable hole 22) when the securing member is disposed in the capture position and the cable is releasable when the securing member is disposed in the release position. For example, with reference to FIG. 3, the lock slide 62 may engage the ratchet teeth 36 of the ratchet mechanism to secure the cable at an engagement position. With the cable 40 secure, the cable length may define a cable loop length (e.g., the length of the cable outside the housing forming a loop). In some embodiments, the object meant to be secured can be at least partially disposed inside this loop. Along these lines, embodiments of the present invention provide for a security device with an adjustable cable loop length so that different types of objects may be secured. As such, in some embodiments, the securing member may be configured to secure the cable at a different engagement position (e.g., a second engagement position) such that the cable defines a different cable loop length (e.g., a second cable loop length).

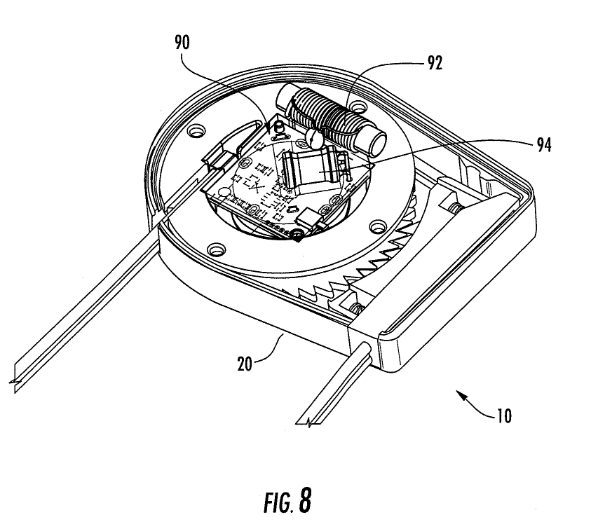

In some embodiments, the ratchet mechanism 30 is configured to allow the cable to be tightened, but not loosened, when the securing member is disposed in the capture position. In one embodiment, the engaging teeth 36 of the ratchet mechanism 30 are tapered as shown in FIGS. 3 and 4 to facilitate rotation relative to the lock slide 62 in a first rotation direction (e.g., winding direction) while preventing rotation relative to the lock slide 62 in a second rotation direction (e.g., unwinding direction). More particularly, the locking teeth 64 of the lock slide 62 may be configured to lock the engaging teeth 36 of the ratchet mechanism 30 to prevent rotation of the ratchet mechanism in the second rotation direction while allowing rotation of the ratchet mechanism 30 in the first rotation direction. For example, in one embodiment, the locking teeth 64 may be configured to define a taper that corresponds generally to that of the engaging teeth 36 as shown in FIG. 8. In this regard, the cable 40 can be wound around the ratchet mechanism 30 and thereby tightened around the object as will be apparent to one of ordinary skill in the art in view of this disclosure.

In some embodiments, the securing member is biased toward the release position. In the depicted embodiment, two springs 65 are supported by flange tabs 68 extending from the housing 20 for biasing the lock slide 62 in an unlocked configuration proximate the locking plate 70. In other embodiments, more or fewer springs may be used.

In some embodiments, the security device may comprise a cam configured to slidably engage the securing member to force the securing member toward the capture position. In some embodiments, the cam may be configured to force the securing member against a bias to secure the cable such that the securing member is in the capture position. As such, in some embodiments, the user may be able move the cam against the securing member to drive the securing member against the bias and toward the capture position. For example, in the depicted embodiment, the security device 10 comprises a cam (e.g., insert 55). In particular, with reference to FIG. 2, the cable 40 comprises a lock end 42 that is securely attached to, or ensleeved by, the cam 55. The security device 10 is in an unlocked position when the cam 55 is removed from the housing 20 as shown in FIG. 2. A lock cavity 25 is defined in the housing 20 for receiving the cam 55. In one embodiment, the cam 55 defines a tapered edge 51 as shown so that sliding the cam 55 into the lock cavity 25 operates to force the lock slide 62 (e.g., securing member) against the bias of springs 65 toward the ratchet mechanism 30 (e.g., toward a capture position). As such, the user may drive the cam (and thus the removable end 42 of the cable) into the housing against the securing member (e.g., lock slide 62) to drive the securing member into the capture position. In such an embodiment, the cam 55 slidably engages the lock slide 62 upon insertion into the cavity 25 and presses the lock slide 62 toward the ratchet mechanism 30 (e.g., spool assembly) along the slide direction until reaching the capture position. As used herein, and as is consistent with the above example embodiments, the user may not necessarily directly drive the securing member toward the capture position and may indirectly drive the securing member by directly moving and/or driving the cam.

In some embodiments, the security device may comprise a locking feature configured to engage the cam to prevent movement of the cam when the securing member is in the capture position. For example, with reference to FIGS. 2-5, the security device 10 comprises a locking assembly 60 (e.g., locking feature) that facilitates gradual tightening of the cable 40 while preventing retraction of the cable 40 (i.e., expansion of the loop) when disposed in a locked configuration. As illustrated in FIG. 2, the locking assembly 60 comprises a locking plate 70 (e.g., an S3 spring), with at least one locking member 76 that is biased to extend away from the locking plate 70 toward the lock slide 62. The locking member(s) 76 may extend from the plate 70 in an angled or tapered manner to allow a cam 55 to pass along the taper and force the locking member 76 to recede against its bias into the locking plate 70. In the depicted embodiment, the locking plate 70 comprises two locking members 76.

In some embodiments, the cam may be configured to interact with the locking feature to prevent movement of the cam when engaged. In such embodiments, the security device may define a locked position when movement of the cam is prevented. For example, the depicted cam 55 further defines at least one receiving feature 56 that is adapted to receive the locking members 76 of the locking plate 70. As will be appreciated by one of ordinary skill in the art in view of this disclosure, when the cam 55 is inserted into the lock cavity 25, the cam 55 drives the locking members 76 toward the locking plate 70, that is, until the locking members 76 snap into the receiving feature(s) 56 of the cam 55. The receiving feature(s) 56 are shaped such that once the locking members 76 have been received into the receiving feature(s), the cam 55 may not be removed from the lock cavity 25, until such time as the locking members 76 are magnetically removed from the receiving feature(s) as will be discussed in greater detail below. Moreover, as is consistent with the above disclosure, the cam 55 forces the lock slide 62 into the capture position to secure the cable from being rotated in the unwinding direction. As such, the security device 10 is now in the locked position with the cable secure. Such a configuration may be useful to secure attachment to an object by having the cable wrapped around it.

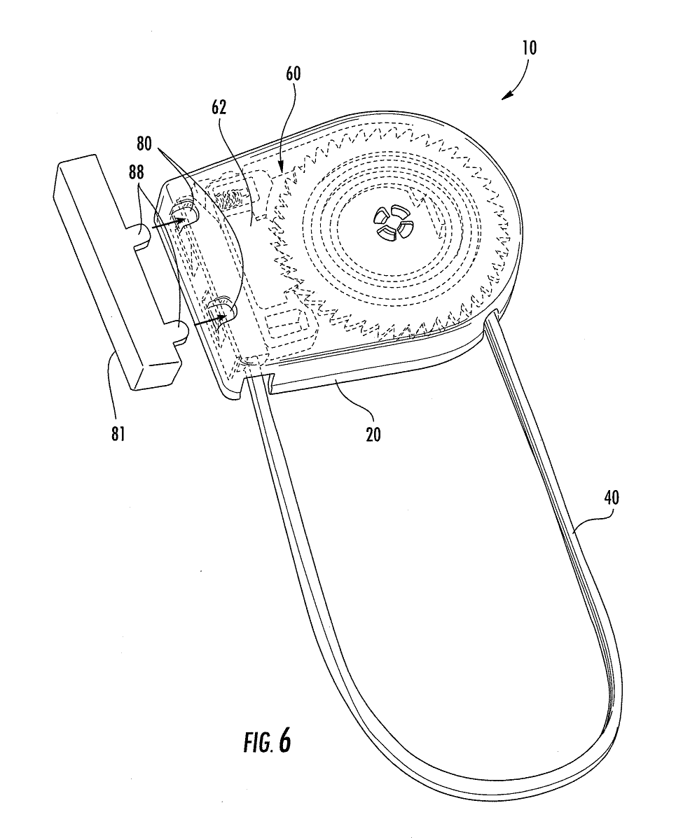

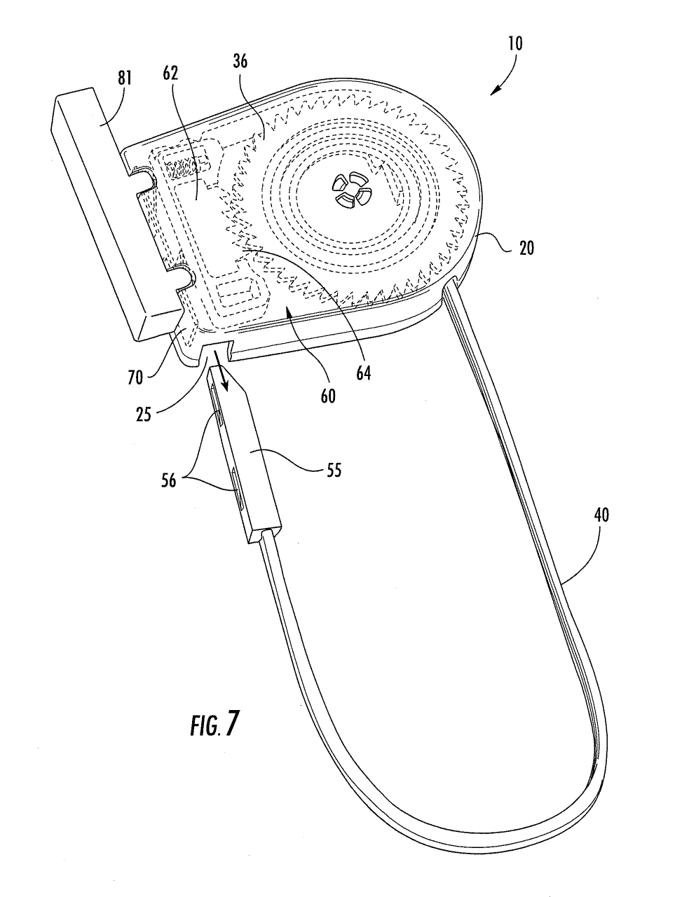

In some embodiments, the security device may define an unlocked position when movement of the cam is not prevented. For example, as seen in FIGS. 6 and 7, a magnetic key 81 can be used to unlock the security device 10. The magnetic key 81 may comprise one or more magnets with locating tabs 88 that correspond to locating features 80 defined in the housing 20. Thus, with reference to FIG. 7, to unlock the security device 10, the magnetic key 81 can be positioned with its locating tabs 88 proximate the locating features 80 of the housing 20 thereby properly positioning the magnetic field produced by the magnet(s) proximate the locking members 76 of the locking plate 70. In one embodiment, the magnetic field retracts the locking members 76 (e.g., the locking members 76 may comprise ferrous material) from the receiving members 56 of the cam 55 thus allowing the cam 55 to be removed from the housing 20 as shown.

Removal of the cam 55 causes the lock slide 62 to transition from the locked position shown in FIG. 3 to the unlocked position shown in FIG. 2. More particularly, in one embodiment, the at least one spring 65 attached to the lock slide 62 operates to drive the lock slide 62 away from the ratchet mechanism 30 toward the unlocked position when the cam 55 is removed. Movement of the lock slide 62 to the unlocked position completely disengages the locking teeth 64 of the lock slide 62 from the engaging teeth 36 of the ratchet mechanism 30 thereby allowing free rotation of the spool 34 in either direction. Thus, the cable 40 can readily be pulled out of the housing 20 (i.e., unwound from the spool 34) in order to loosen the cable 40 or remove the cable 40 from an object.

In another embodiment, as shown in FIG. 2A, the locking assembly 60 of the security device 10 may comprise at least one locking pin or tab 77. In the depicted embodiment, the locking pin 77 is biased toward the lock slide 62 by a spring 75 supported by a tab 78, though other biasing means may be used to bias the locking pin 77. The locking pin 77 may also be configured to fit securely into the receiving feature 56 of the cam 55 when the cam 55 is disposed in the housing 20 such that the security device 10 is disposed in a locked configuration. In the depicted embodiment, the locking assembly 60 comprises two locking pins 77 configured to fit into two receiving features 56 on the cam 55.

Similar to the embodiments described above, the security device 10 shown in FIG. 2A may be placed into a locked configuration by inserting the cam 55 into the housing 20, whereby the at least one locking pin 77 engages with a complementary receiving feature 56 of the cam 55 from the force of the bias of the spring 75. With the locking pin 77 engaged with the receiving feature 56 the cam 55 may not be pulled out of the housing 20.

The security device 10 shown in FIG. 2A may be placed in an unlocked configuration with a magnetic key, such as the magnetic key 81 described below with respect to FIGS. 6 and 7. The locking pin 77 may comprise ferrous material such that placing a magnetic key proximate to the locking pin 77 will retract the locking pin 77 against the bias of the spring 75. Thus, the locking pin 77 will retract out of the receiving feature 56 to allow the cam 55 to be removed from the housing 20. As described herein, some embodiments of the security device 10 may comprise a locking assembly 60 with at least one locking pin 77 instead of the locking plate 70 previously described.

In another embodiment, the security device 10 may define a compact design, such that the spin cap 32 and ratchet mechanism 30 can be engaged simply by a user's thumb and forefinger (not shown). The compact design allows the security device 10 to not only secure a smaller object, but also remain securely attached to an object while a customer handles that object. Another benefit of a compact design is that the security device 10 can remain securely attached to an object on display without blocking consumer's view of the object or drawing undue attention from the object.

### Thumb Lock Embodiment

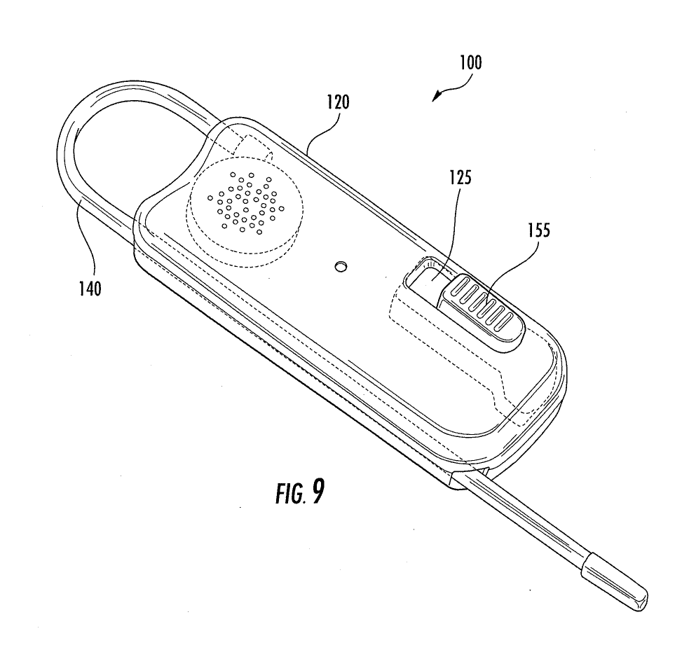

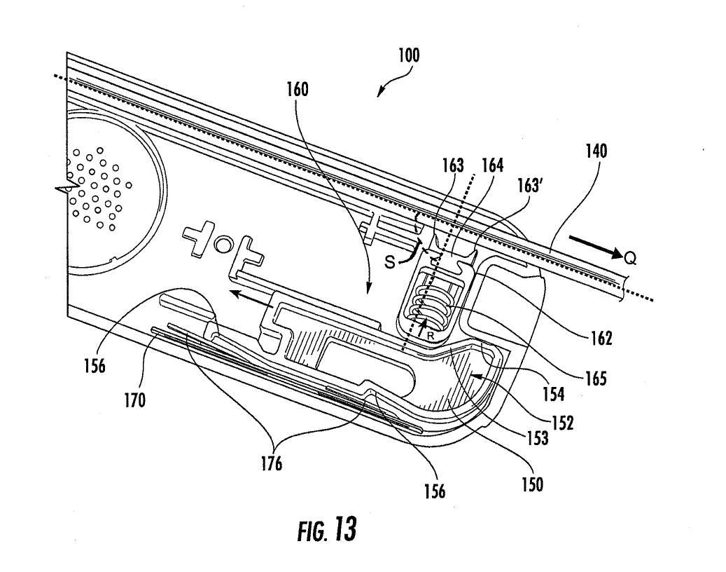

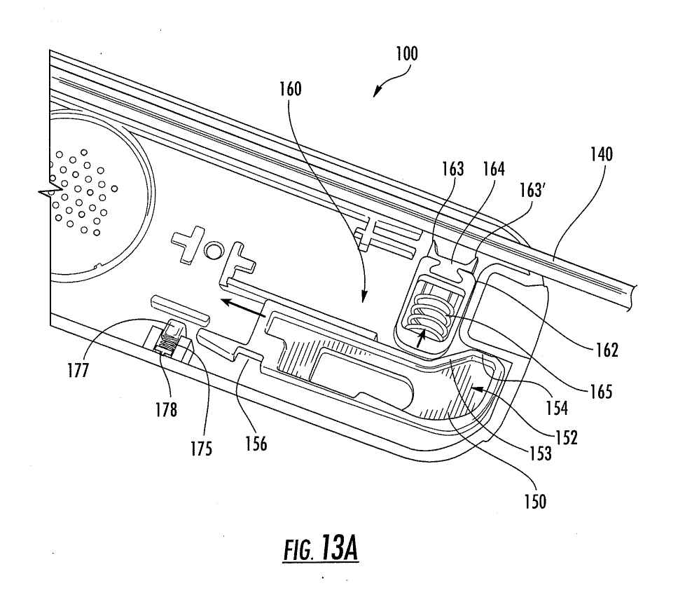

FIG. 9 shows another example embodiment of a security device configured for secure attachment to an object. The security device 100 shown in FIG. 9 may be referred to as a “thumb-lock” and, in some embodiments, may be structured to include a grip operable by the thumb of a user. The depicted security device 100, similar to the security device 10 shown in FIG. 1, comprises a housing 120 and a cable 140. However, in the depicted embodiment, the security device 100 relies on a thumb lock type locking assembly 160 (shown in FIG. 13) to provide appropriate locking of the cable 140 in the locked position as will be discussed in greater detail below.

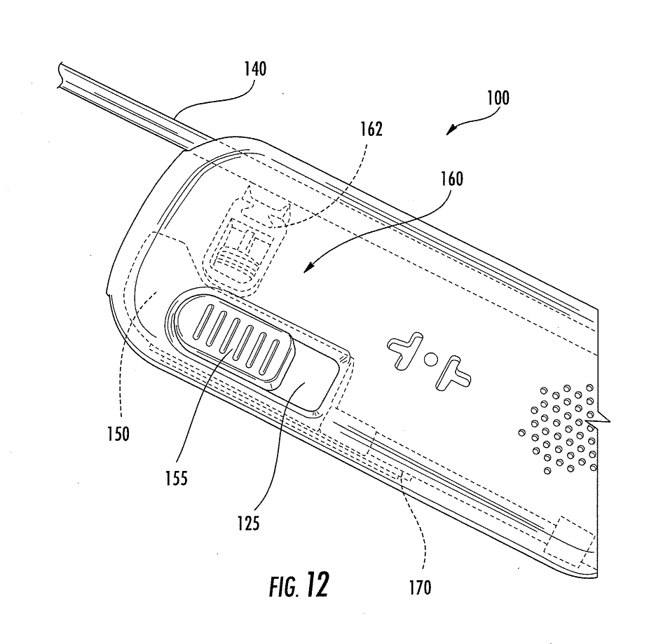

Referring to FIGS. 12-14, the security device 100 comprises a locking assembly 160 that locks the cable 140 at a desired length when disposed in a locked configuration. Notably, in contrast to the ratchet type embodiments of FIGS. 1-8, the thumb lock type locking assembly 160 of the present embodiment prevents loosening and tightening of the cable when the security device 100 is disposed in the locked configuration.

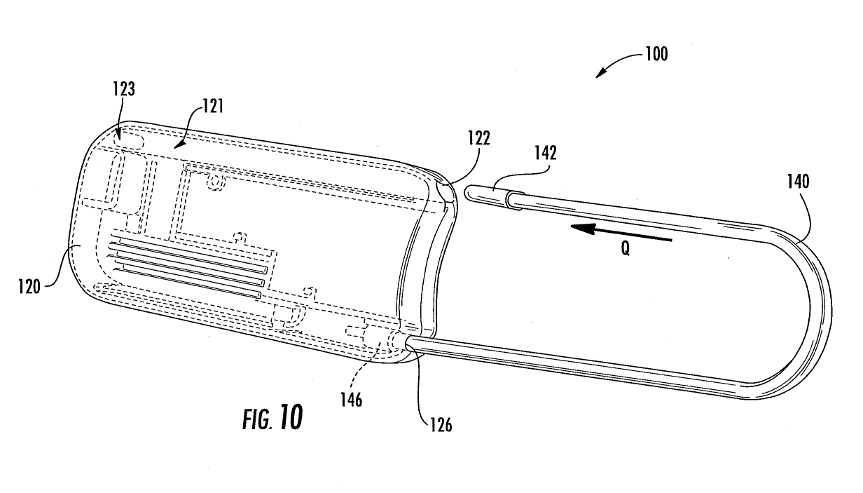

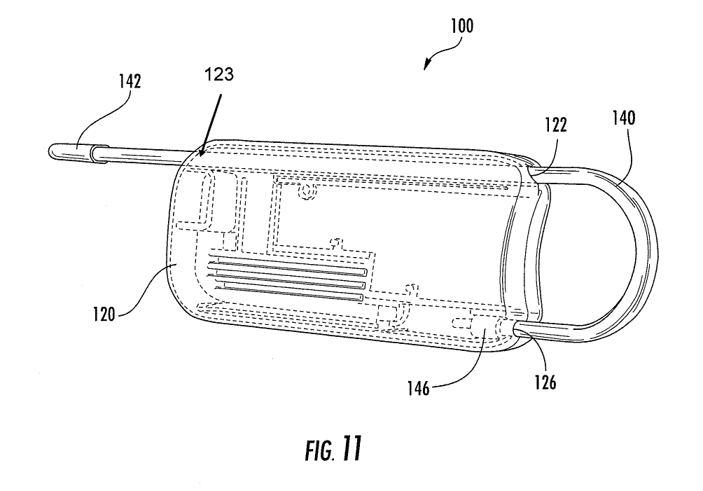

The security device may comprise a cable defining an anchor end and a removable end. For example, referring to FIGS. 10 and 11, the cable 140 comprises an anchor end 146 and a removable end 142. The anchor end 146 is securely anchored inside the housing 120. To achieve anchoring, the anchor end 146 of the cable 140 may have a cap or otherwise define a larger diameter than the rest of the cable 140. As such, the housing 120 could be defined with an anchor hole 126 that is big enough to receive the cable 140 but small enough to prevent removal of the anchor end 146.

In some embodiments the cable may be configured to extend at least partially into the housing in a first direction. With reference to FIGS. 10 and 11, in the depicted embodiment, the removable end 142 of the cable 140 is configured to pass into the housing 120 in a first direction (e.g., along arrow Q). In some embodiments, the cable 140 of the security device 100 may be defined to pass completely through the housing 120, such as through cable holes 122, 123. For example, the housing 120 may define a first end (e.g., cable hole 122) and a second end (e.g., cable hole 123) and a cavity 121 defined therebetween. The removable end 142 of the cable may be inserted into the cavity 121 proximate the first end 122 and pass fully through the housing 120 to at least partially protrude from the housing 120 proximate the second end 123.

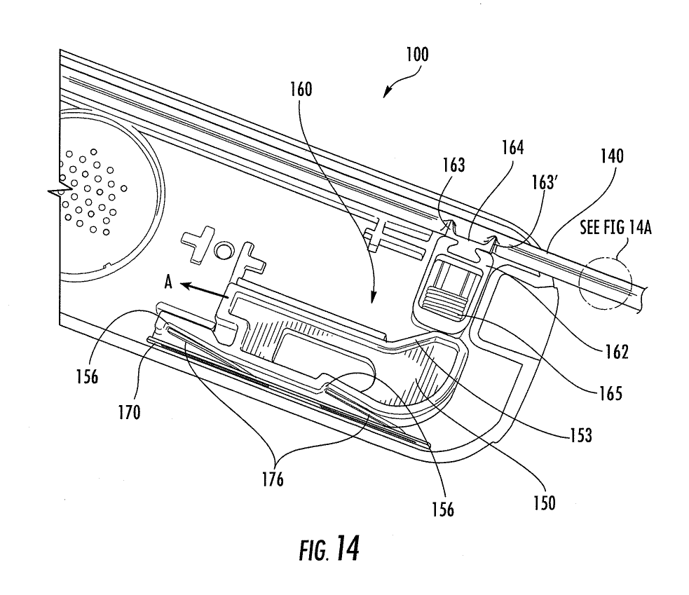

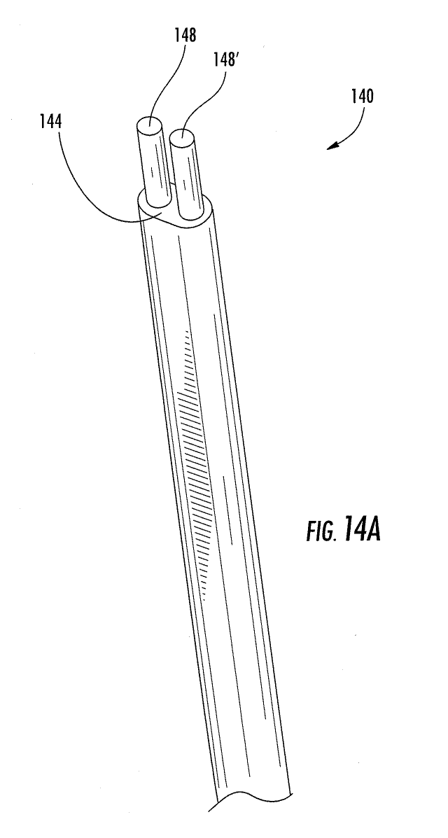

The security device may comprise a securing member supported by the housing and drivable along a slide direction between a capture position and a release position. In some embodiments, the securing member is drivable by a user along the slide direction. For example, the security device 100 may comprise a lock 162 (e.g., securing member). In one embodiment, the lock 162 is configured to move from a release position (shown in FIG. 13) to a capture position (shown in FIG. 14). In some embodiments, the securing member (e.g., lock 162) may be biased in the release position. For example, in the depicted embodiment, a spring 165 supported by a flange tab 168 extending from the housing 120 operates to bias the lock 162 in the release position.

The securing member may be configured to secure the cable to prevent removal of the cable from the housing when in the capture position. In some embodiments, the securing member may be configured to secure the removable end of the cable to prevent removal of the cable from the housing. For example, in the depicted embodiment, the lock 162 is configured to move into the capture position (e.g., along arrow R shown in FIG. 13) to engage the removable end 142 of the cable 140 in the capture position to prevent movement of the cable 140. With the cable 140 secure, the cable length may define a cable loop length (e.g., the length of the cable outside the housing forming a loop). In some embodiments, the object meant to be secured can be at least partially disposed inside this loop. Along these lines, embodiments of the present invention provide for a security device with an adjustable cable loop length so that different types of objects may be secured. As such, in some embodiments, the securing member may be configured to secure the cable at a different engagement position (e.g., a second engagement position) such that the cable defines a different cable loop length (e.g., a second cable loop length).

With reference to FIG. 13, the slide direction (e.g., along arrow R) may form a capture angle S relative to the first direction of the cable (e.g., along arrow Q). In the depicted embodiment, the capture angle S defines approximately a 90° angle. In some embodiments, the capture angle may define a different angle (e.g., any angle from approximately 30° to approximately 150°).

In some embodiments, the securing member is configured to crimp the cable to prevent removal of the cable form the housing. In the depicted embodiment, the lock 162 comprises a clamp feature 164 that engages with the cable 140 in the capture position. Additionally or alternatively, the securing member may comprise at least two teeth configured to protrude at least partially into the cable to prevent removal of the cable from the housing when the securing member is in the capture position. For example, the clamp feature 164 may be comprised of oppositely arranged first and second teeth 163, 163′ as shown. This arrangement of the first and second teeth 163, 163′ resists an amount of pull-force on the cable 140 (e.g., 45 lbs-force) that may be applied perpendicular (e.g., a capture angle of 90°) to the force applied by the teeth 163, 163′ to the cable 140 in an attempt to pull the cable 140 out of the housing 120 when the security device 100 is locked. In addition, the depicted arrangement of first and second teeth 163, 163′ provide for cost effective manufacturing, wherein the teeth 163, 163′ may be made of a material suitable to properly secure the cable 140 (e.g., extruded aluminum). In other embodiments, the clamp feature 164 may be comprised of differently configured teeth, tabs, flat clamping surfaces, wedges, or ball bearings, which are configured to engage and secure the cable. Some different arrangements of teeth 163 are provided in TABLE A, further discussed below.

As used herein, “crimping” the cable is not meant to be limited to a specific engagement and encompassing many manners of engagement (e.g., squeeze, pinch, removably deform, deform, etc.) Moreover, in some embodiments, the cable may be deformed from the crimp action, whereas in other embodiments, the cable may not be deformed, and thus be able to be re-crimped over and over again.

Applicant has identified a number of attributes that may be important for cables used in security devices that are structured in accordance with embodiments of the invention. For example, since the security device 100 can be configured to lock the cable 140 at a desired length by using a clamp feature 164, the cable 140 must be strong enough to withstand the force applied by the clamp feature 164 during repeated uses. Additionally, the cable 140 must be flexible and maneuverable so as to secure even oddly shaped objects while also presenting a non-abrasive surface to reduce or eliminate damage to any object so secured. As will be apparent to one of ordinary skill in the art, depending upon the applications, a variety of other cable or cable-like structures could be used, such as ribbon, wire, zip-tie type structures and the like.

In reference to FIG. 14A, the depicted cable 140 is comprised of cables 148, 148′, and sheathing 144. The sheathing 144 binds the cables 148, 148′ together and acts to insulate the cables 148, 148′ in circumstances where an electrical current is run through the cables 148, 148′. The sheathing 144 may also provide protection from cable abrasion to the object when the object is securely attached. One important purpose of the sheathing 144 is to protect the cables 148, 148′ from the teeth 163 of the clamp feature 164 when the security device 100 is locked. For example, in the depicted embodiment of FIG. 14 and with reference to FIG. 14A, the first and second teeth 163, 163′ sufficiently engage the sheathing 144 of the cable 140 to resist an amount of pull-force (e.g., 45 lbs-force) that may be exerted on the cable 140 when the security device 100 is in the locked configuration. At the same time however, the first and second teeth 163, 163′ do not penetrate or pierce the sheathing 144 thereby contacting either cable 148, 148′. In the depicted embodiment, the cables 148, 148′ are made from galvanized steel; however, in other embodiments stainless steel may be used. The depicted sheathing is made from polyvinyl chloride (PVC) and defines a thickness of 0.70 mm on the side of the cable 140 where the teeth 163 of the clamp feature 164 engage the cable 140 when in the locked configuration.

Other embodiments of the security device 100 may employ a different arrangement or number of teeth 163 for the clamp feature 164 and those teeth 163 may protrude to a different depth into the sheathing 144 of the cable 140 when in the locked configuration. These varied embodiments may require a different amount of lock-force on the grip 155 to lock the security device 100 and they may resist a different amount of pull-force perpendicular to the clamp feature 164 when in the locked configuration. As such, a specific clamp feature configuration can be tailored for different circumstances. Thus, testing was performed on different numbers and arrangements of teeth 163 at different protrusion depths into the sheathing 144 when in the locked configuration and the amount of lock-force required and pull-force resisted were measured. These results are shown in the following table, wherein the arrangement of the teeth 163 are indicated as a “1” for a tooth and a “-” for no tooth (e.g., the arrangement of the first and second teeth 163, 163′, shown in FIG. 14, correspond to (1-1)):

TABLE A

| | | Protrusion | | |
|---|---|---|---|---|
| Number | Arrangement | Depth | Lock-Force | Pull-Force |
| of Teeth | (1 = tooth; _= no tooth) | (mm) | (lb-f) | (lb-f) |
| 5 | (1 1 1 1 1) | 0.9 | 15 | 62.5 |
| 5 | (1 1 1 1 1) | 0.7 | 14.7 | 61.4 |
| 5 | (1 1 1 1 1) | 0.6 | 8 | 33 |
| 3 | (— 1 1 1 —) | 0.6 | 8 | 30 |
| 4 | (1 1 1 1 —) | 0.6 | 7 | 25.5 |
| 2 | (1 1 — — —) | 0.6 | 7.2 | 31.1 |
| 3 | (— 1 1 1 —) | 0.7 | 8.1 | 25.6 |
| 2 | (1 1 — — —) | 0.7 | 12.7 | 35.7 |
| 2 | (1 1 — — —) | 1.1 | 11.8 | 35.4 |
| 1 | (— — — — 1) | 1.1 | 10.1 | 31.3 |
| 3 | (1 — 1 — 1) | 1.1 | 12.2 | 37.5 |

In some embodiments, the security device comprises a cam configured to slidably engage the securing member to force the securing member into the capture position. For example, the security device 100 shown in FIG. 9 includes a housing 120 that defines a grip cavity 125. A grip 155 extends from a slide 150 (e.g., cam), shown in FIG. 13, through the grip cavity 125. The grip cavity 125 is configured so that a grip 155 is accessible to a user (e.g., through the housing) and is shaped as a slot to allow for slidable movement of the grip 155. Movement or sliding of the grip 155 within the grip cavity 125 causes the lock 162 to transition from the release position to the capture position. Additionally, as will be discussed in greater detail below, in some embodiments, movement or sliding of the grip 155 within the grip cavity 125 causes the security device 100 to transition from a locked position to an unlocked position and vice versa. As used herein, the grip may be positionable and/or driveable by the user, and may protrude through the housing or by accessible through the housing (e.g., through the grip cavity). Additionally, reference to a grip should not be limited to a friction structured surface (e.g., rubber, rib covered, etc.).

In some embodiments, the cam may be configured to force the securing member against a bias into the capture position. In some embodiments, the user may move the cam against the securing member to drive the securing member against the bias and toward the capture position. In various embodiments, upward movement of the slide 150 from the position shown in FIG. 13 to the position shown in FIG. 14 operates to drive the lock 162 from an unclamped position (e.g., the release position shown in FIG. 13) to a clamped position (e.g., the capture position shown in FIG. 14). In one embodiment, as discussed above, a user facilitates movement of the slide 150 by sliding the grip 155 (which may extend through the housing 120) within the grip cavity 125 (shown in FIG. 12) using his or her thumb. In some embodiments, the drive element 152 of the slide 150 defines a tapered drive surface 153 that is configured to laterally drive the lock 162, against the bias of spring 165, from the unclamped position to the clamped position as the slide 150 is moved in the direction of arrow A (shown in FIG. 14). As used herein, and as is consistent with the above example embodiments, the user may not necessarily directly drive the securing member toward the capture position and may indirectly drive the securing member by directly moving and/or driving the cam.

In some embodiments, the security device comprises a locking feature configured to engage the cam to prevent movement of the cam when the securing member is in the capture position. For example, with reference to FIG. 13, the security device 100 comprises a locking assembly 160 comprising a locking plate 170 (e.g., S3 spring) structured generally as described above in connection with FIGS. 1-8. The locking plate 170 may comprise locking members 176 comprising ferrous material such that placing a magnetic key proximate to the locking plate 170 and/or locking members 176 will retract the locking member 176 against the bias of the locking members. In one embodiment, the slide 150 further defines one or more cavities or receiving features 156 that are adapted to slidably receive one or more spring biased locking members 176 extending from the locking plate 170.

In some embodiments, the security device may define a locked position when movement of the cam is prevented. For example, as noted above, moving the slide 150 into engagement with the lock 162 drives the lock 162 into the clamped position. In some embodiments, the slide 150 may include a lock surface 154 configured to rest against the lock 162 as shown in FIG. 14. With the lock surface 154 operating to support the lock 162 in the clamped position despite the opposing spring bias of spring 165, the slide 150 prevents movement of the securing member from the capture position. Additionally, to prevent movement of the slide 150 (and thereby prevent movement of the lock 162), the locking members 176 are received into the receiving features 156 such that the slide 150 is held in place, thereby placing the security device 100 in the locked position. To further explain, in some embodiments, the locking members 176 of the locking plate 170 snap into the receiving features 156 of the slide 150 once the slide 150 has moved sufficiently to drive the lock 162 into a clamped position. In this regard, the slide 150 is prevented from moving in a direction opposite to arrow A and the security device 100 is locked in a locked position.

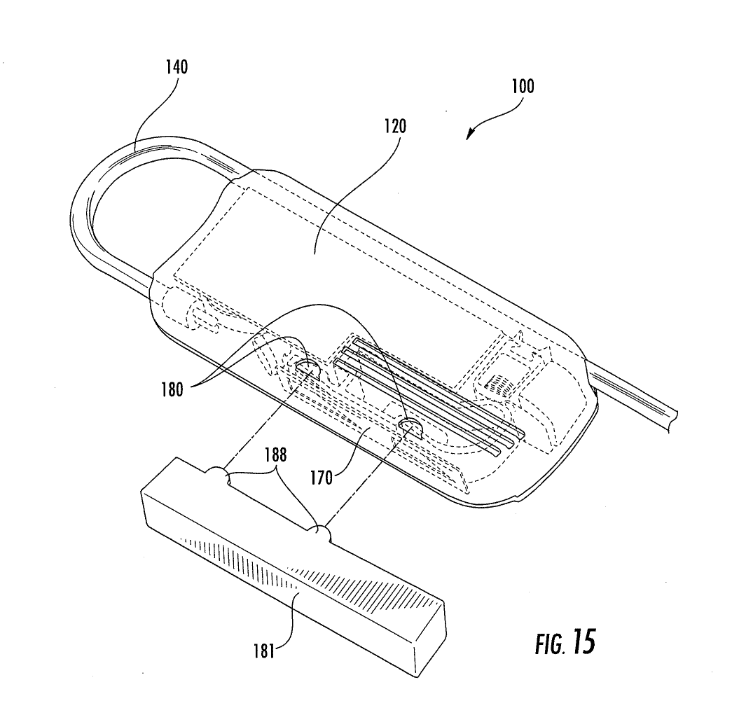

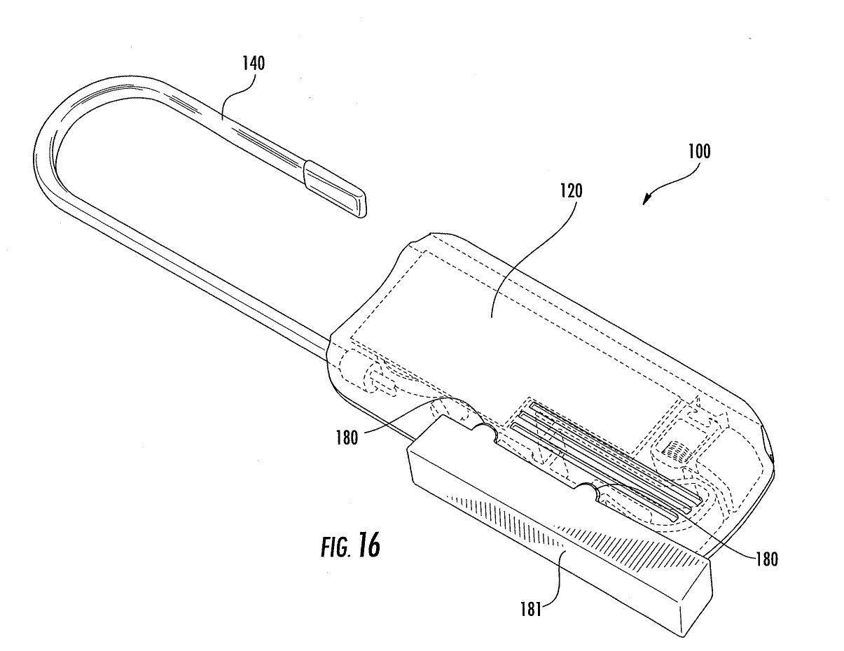

In some embodiments, the security device may define an unlocked position when movement of the cam is not prevented. For example, the security device 100 may be unlocked with a magnetic key 181, similar the unlocking of the security device 10 as described with respect to FIGS. 6 and 7. In reference to FIGS. 15 and 16, the magnetic key 181 may comprise one or more locating tabs 188 that correspond to locating features 180 defined in the housing 120. Thus, to unlock the security device 100, the magnetic key 181 can be positioned with its locating tabs 188 proximate the locating features 180 of the housing 120 thereby properly positioning the magnetic field produced by the magnet(s) of the magnetic key 181 proximate the locking members 176 of the locking plate 170. In one embodiment, the magnetic field retracts the locking members 176 (e.g., the locking members 176 may comprise ferrous material) from the receiving members 156 of the slide 150 thus allowing the slide 150 and lock 162 to be returned to their unlocked and unclamped positions as shown in FIG. 13.

In another embodiment, as shown in FIG. 13A, the locking assembly 160 of the security device 100 may comprise at least one locking pin 177. In the depicted embodiment, the locking pin 177 is biased toward the lock 162 by a spring 175 supported by a tab 178, though other biasing means may be used to bias the locking pin 177. The locking pin 177 may also be configured to fit securely into the receiving feature 156 of the slide 150 when the slide 150 is disposed in the housing 120 such that the security device 100 is in a locked position.

The security device 100 shown in FIG. 13A may be placed into a locked position by moving the slide 150 in the housing 120 so that the locking pin 177 engages with a complementary receiving feature 156 on the slide 150. As the receiving feature 156 of the slide 150 is moved proximate the locking pin 177, the locking pin 177 is forced into the receiving feature 156 from the force of the bias of the spring 175. With the locking pin 177 engaged with the receiving feature 156 the slide 150 may not be moved back to an unlocked position in the housing 120.

The security device 100 shown in FIG. 13A may be placed in an unlocked position with a magnetic key, such as the magnetic key 181 described below with respect to FIGS. 15 and 16. The locking pin 177 may comprise ferrous material such that placing a magnetic key proximate to the locking pin 177 will retract the locking pin 177 against the bias of the spring 175. Thus, the locking pin 177 will retract out of the receiving feature 156 to allow the slide 150 to be repositioned to the unlocked position in the housing 120. As described herein, some embodiments of the security device 100 may comprise a locking assembly 160 with at least one locking pin 177 instead of the locking plate 170 previously described.

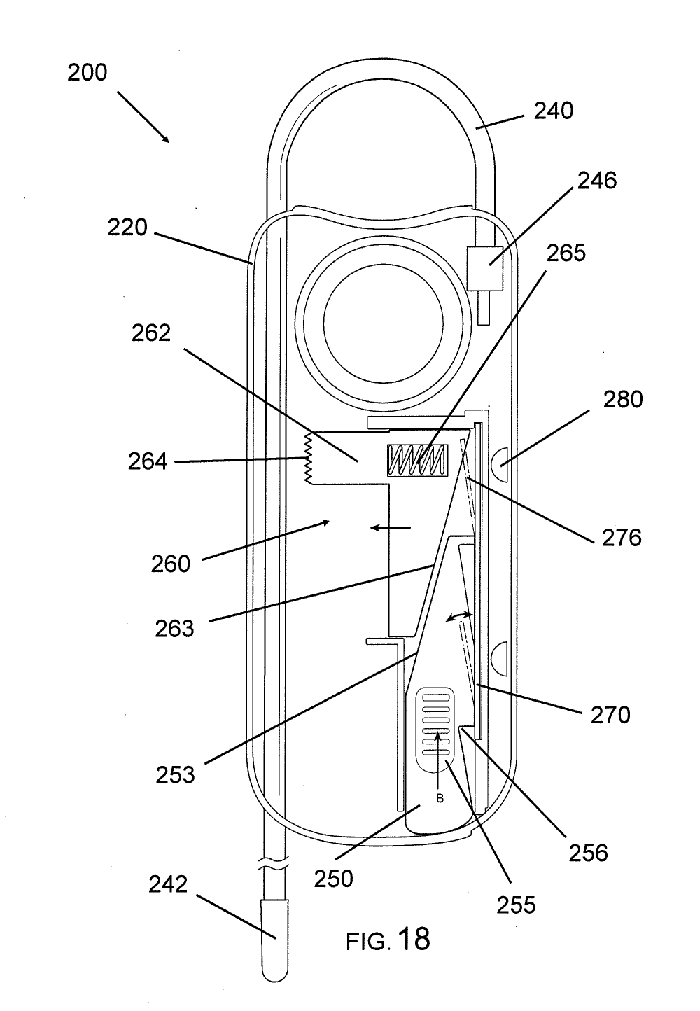

FIGS. 18-20 illustrate security devices having similar “thumb-lock” type locking assemblies structured in accordance with various embodiments of the invention. Similar to other embodiments discussed above, each of the depicted security devices 200, 300, 500 comprise a housing 220, 320, 520 and a cable 240, 340, 540. The cables 240, 340, 540 define a removable end 242, 342, 542 and a captured or anchor end 246, 346, 546. Embodiments of the present invention described with respect to FIGS. 18-20 are shown with a locking plate 270, 370, 570. However, the locking plate 270, 370, 570 may be replaced with at least one locking pin, similar to those embodiments described with respect to FIGS. 2A and 13A for security devices 10 and 100, respectively.

FIG. 18 depicts a security device 200 having a thumb slide type locking assembly 260 structured in accordance with another embodiment of the invention. The depicted locking assembly 260 comprises a slide 250, a lock 262, and a locking plate 270.

The lock 262 (e.g., securing member) is biased in an unclamped position (e.g., release position) by a spring 265 that is supported by a flange tab (not shown) extending from the housing. The lock 262 defines a tapered driven surface 263 and further comprises at least one clamp feature 264 configured to engage the cable 240 when the lock 262 is disposed in a clamped position (e.g., capture position) to prevent movement of the cable 240.

The slide 250 (e.g., cam) defines a grip 255 configured to allow a user to move the slide 250 along arrow B to engage the lock 262. The slide 250 further defines a drive surface 253 that is configured to engage or drive the driven surface 263 defined by the lock 262. In one embodiment, the drive surface 253 of the slide 250 is substantially parallel to the driven surface 263 of the lock 262. In another embodiment, the drive surface 253 of the slide 250 and the driven surface 263 of the lock 262 are each tapered at a 45 degree angle. In other embodiments, other taper angles may be used, though tapered angles of 45 degrees or less are preferred.

In one embodiment, as the slide 250 is moved along arrow B, the drive surface 253 of the slide 250 forces the driven surface 263 of the lock 262, against the bias of the spring 265, along a slide direction to a clamped position (e.g., capture position). As discussed above in connection with other embodiments, the slide 250 defines one or more cavities or receiving features 256 that are adapted to slidably receive one or more spring biased locking members 276 extending from the locking plate 270 (e.g., locking feature). In the depicted embodiment, the locking members 276 of the locking plate 270 snap into the receiving features 256 of the slide 250 once the slide 250 has moved sufficiently to drive the lock 262 into its clamped position. In this regard, the slide 250 is prevented from moving in a direction opposite to arrow B and the security device 200 is locked in a locked position.

To unlock the security device 200 according to one embodiment, a magnetic key (not shown), similar to the magnetic key 181 in FIGS. 15-16, is used. The magnetic key may comprise one or more locating tabs (not shown) that correspond to locating features 280 defined in the housing 220. Thus, to unlock the security device 200, the magnetic key can be positioned with its locating tabs proximate the locating features 280 of the housing 220 thereby properly positioning the magnetic field produced by the magnet(s) of the magnetic key proximate the locking members 276 of the locking plate 270. In one embodiment, the magnetic field retracts the locking members 276 from the receiving members 256 of the slide 250 thus allowing the slide 250 and lock 262 to be returned to their unlocked and unclamped positions.

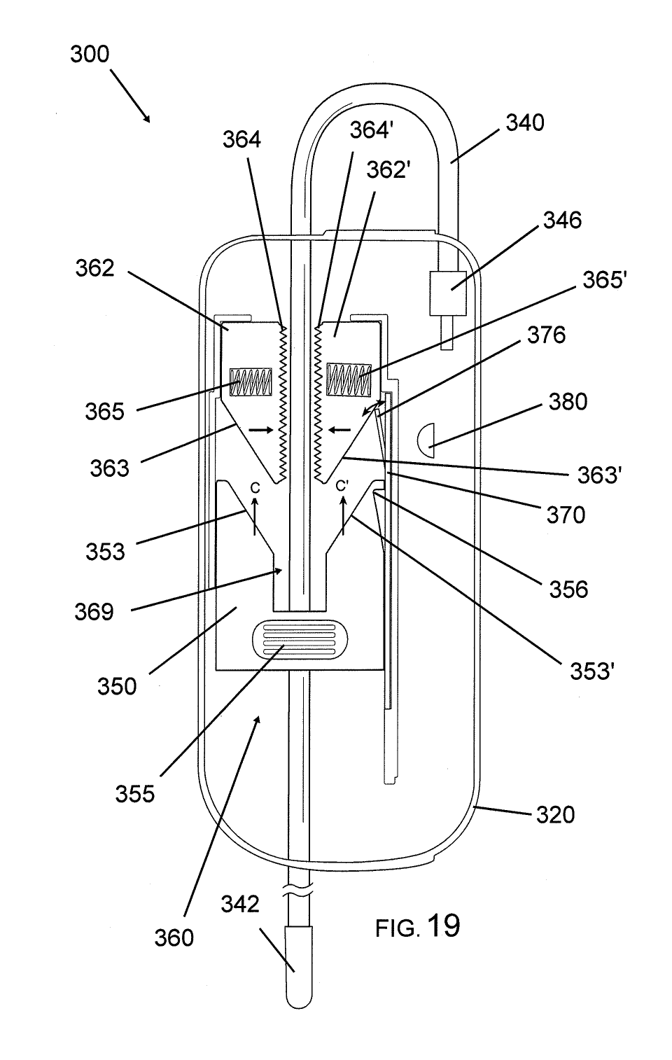

In some embodiments, the security device may comprise two securing members positioned opposite each other with respect to the cable. The securing members may be configured to secure the cable therebetween to prevent removal of the cable from the housing. For example, FIG. 19 depicts a security device 300 having a thumb slide type locking assembly 360 with two securing members (e.g., locks 362, 362′). The depicted locking assembly 360 comprises a slide 350, two locks 362, 362′, and a locking plate 370.

The depicted embodiment includes a second securing member (e.g., lock 362′) that is drivable by the user from a second release position to a second capture position. Additionally, the cable is positioned between the second securing member (lock 362′) and the securing member (lock 362). Thus, the user can move the cam (e.g., slide 350) against the securing member and the second securing member to drive the securing member the second securing member to the capture position and the second capture position respectively. Though the above description details a first and second capture position and first and second release position, a similar collective capture position and release position for both securing members may be referred to herein.

To further explain, the two locks 362, 362′ are positioned on opposing sides of the cable 340, and are biased in an unclamped position (e.g., release position) by two opposing springs 365, 365′ that are each supported by flange tabs extending from the housing (now shown). Each lock 362, 362′ comprises a driven surface 363, 363′ and at least one clamp feature 364, 364′ configured to engage the cable 340 when disposed in a clamped position (e.g., capture position).

The slide 350 (e.g., cam) defines a grip 355 configured to allow a user to move the slide 350 along arrow C/C′ to engage the two locks 362, 362′. The slide 350 further defines a lock receiving cavity 369 and two drive surfaces 353, 353′ that are configured to engage or drive the two corresponding driven surfaces 363, 363′ defined by each lock 362, 362′. In one embodiment, the drive surfaces 353, 353′ of the slide 350 are substantially parallel to their corresponding driven surfaces 363, 363′ of the locks 362, 362′. In another embodiment, the drive surfaces 353, 353′ of the slide 350 and the driven surfaces 363, 363′ of the locks 362, 362′ are each tapered at a 45 degree angle.

In one embodiment, as the slide 350 is moved from its first position to its second position along arrows C, C′, the drive surfaces 353, 353′ of the slide 350 force the driven surfaces 363, 363′ of the locks 362, 362′ against the bias of the springs 365, 365′, to a clamped position. In the depicted embodiment, as the locks 362, 362′ clamp down on the cable 340 and the slide 350 moves along lines C, C′, portions of the locks 362, 362′ may extend into the lock receiving cavity 369 defined in the slide 350. As discussed above in connection with other embodiments, the slide 350 defines one or more cavities or receiving features 356 that are adapted to slidably receive one or more spring biased locking members 376 extending from the locking plate 370 (e.g., locking feature). In the depicted embodiment, the locking members 376 of the locking plate 370 snap into the receiving features 356 of the slide 350 once the slide 350 has moved sufficiently to drive the locks 362, 362′ into its clamped position. In this regard, the slide 350 is prevented from moving in a direction opposite to arrows C, C′ and the security device 300 is locked in a locked position.

To unlock the security device 300 according to one embodiment, a magnetic key (not shown), similar to the magnetic key 181 in FIGS. 15-16, is used. The magnetic key may comprise one or more locating tabs (not shown) that correspond to locating features 380 defined in the housing 320. Thus, to unlock the security device 300, the magnetic key can be positioned with its locating tab proximate the locating feature 380 of the housing 320 thereby properly positioning the magnetic field produced by the magnet(s) of the magnetic key proximate the locking member 376 of the locking plate 370. In one embodiment, the magnetic field retracts the locking member 376 from the receiving member 356 of the slide 350 thus allowing the slide 350 and locks 362, 362′ to be returned to their unlocked and unclamped positions.

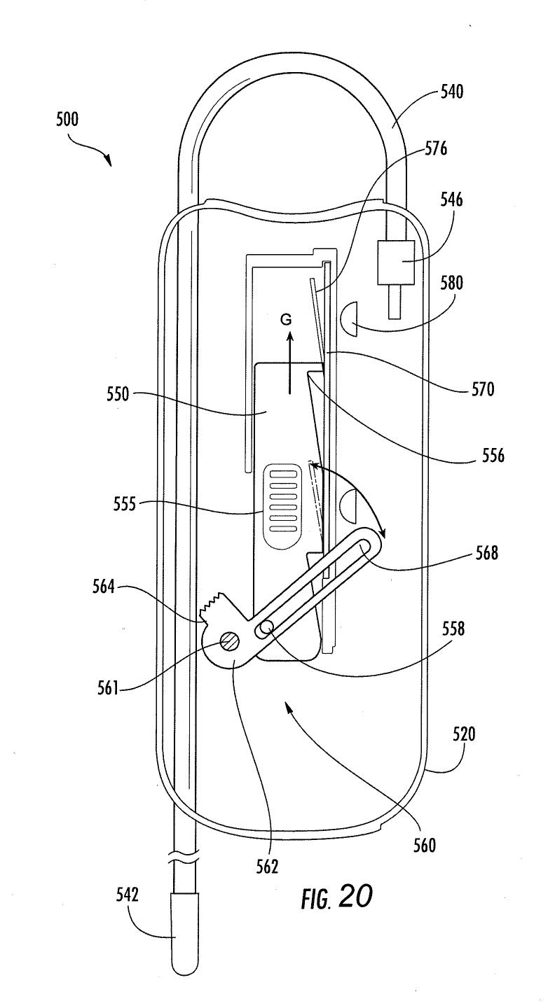

FIG. 20 shows another example embodiment of a security device configured for secure attachment to an object. In particular, FIG. 20 depicts a security device 500 having a thumb slide and linkage type locking assembly 560 structured in accordance with another embodiment of the invention. The depicted locking assembly 560 comprises a slide 550, a lock 562, and a locking plate 570.

In the depicted embodiment, the securing member (e.g., lock 562) is rotatably supported within the housing 520 and the securing member may be driven by the user to rotate from a release position to the capture position. The lock 562 (e.g., securing member) defines a lock slot 568 and comprises at least one clamp feature 564 designed as a surface that rotates around a pivot point 561 to engage and clamp the cable 540 when the lock 562 is disposed in a clamped position (e.g., capture position). In some embodiments, the lock 562 may be biased to the unclamped position (e.g., release position).

The slide 550 (e.g., cam) defines a grip 555 configured to allow a user to move the slide 550 to engage the lock 562. The slide 550 comprises a tab 558 configured to interact with the lock slot 568 such that when the slide 550 moves from its first position to its second position, along arrow G, the tab 558 forces the lock slot 568 and the lock 562 to rotate around the pivot point 561 to a clamped position where the clamp feature 564 securely engages and clamps the cable 540. As discussed above in connection with other embodiments, the slide 550 also defines one or more cavities or receiving features 556 that are adapted to slidably receive one or more spring biased locking members 576 extending from the locking plate 570 (e.g., locking feature). In the depicted embodiment, the locking members 576 of the locking plate 570 snap into the receiving features 556 of the slide 550 once the slide 550 has moved sufficiently to rotate the lock 562 into a clamped position. In this regard, the slide 550 is prevented from moving in a direction opposite to arrow G and the security device 500 is locked in a locked position.

To unlock the security device 500 according to one embodiment, a magnetic key (not shown), similar to the magnetic key 181 in FIGS. 15-16, is used. The magnetic key may comprise one or more locating tabs (not shown) that correspond to locating features 580 defined in the housing 520. Thus, to unlock the security device 500, the magnetic key can be positioned with its locating tabs proximate the locating features 580 of the housing 520 thereby properly positioning the magnetic field produced by the magnet(s) of the magnetic key proximate the locking members 576 of the locking plate 570. In one embodiment, the magnetic field retracts the locking members 576 from the receiving members 556 of the slide 550 thus allowing the slide 550 and lock 562 to be returned to their unlocked and unclamped positions.

### Floating Shuttle Embodiment

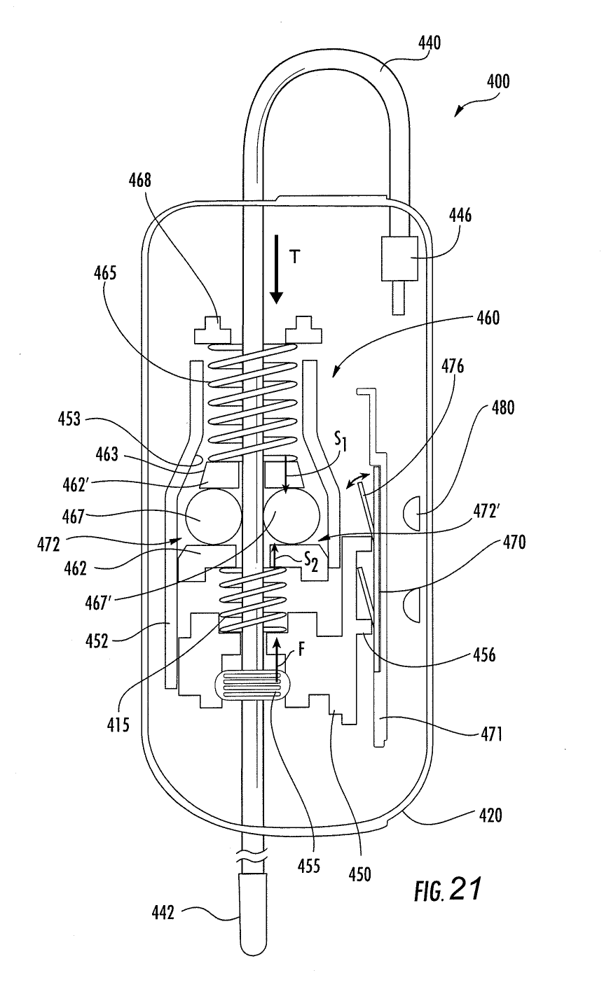

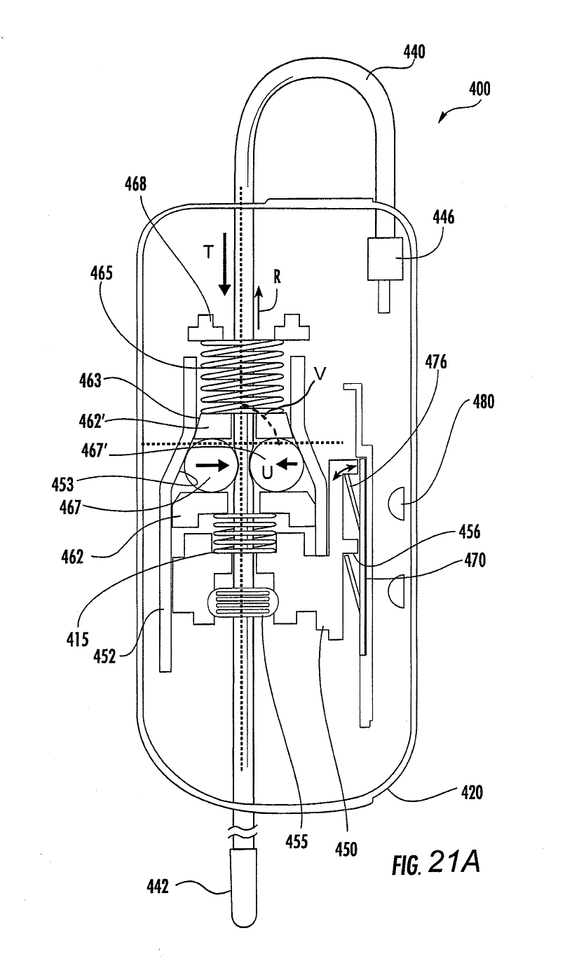

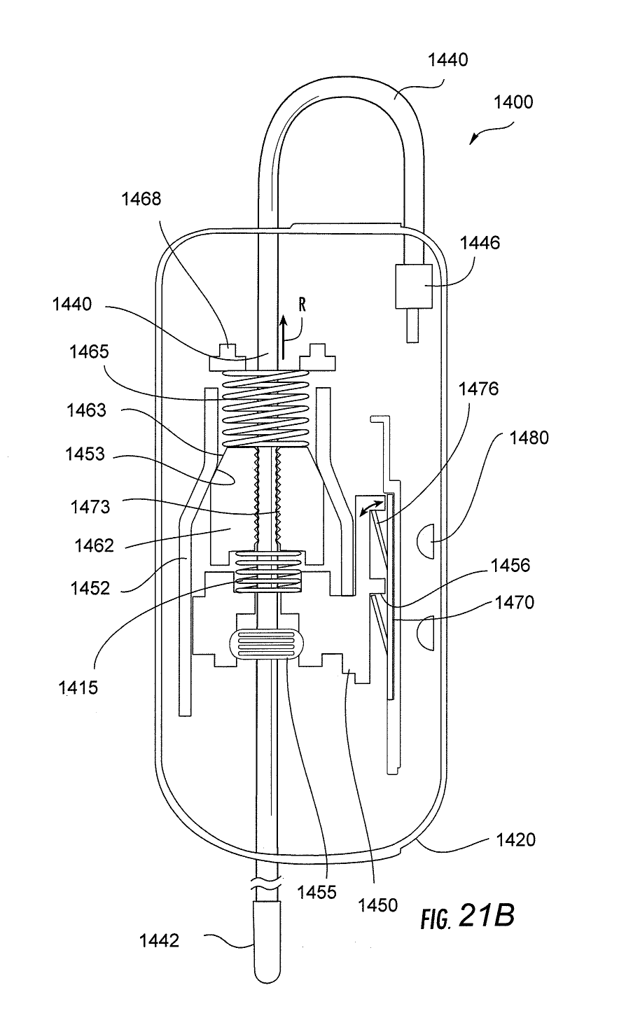

FIG. 21 shows another example embodiment of a security device configured for secure attachment to an object. The security device 400 (shown in partial section view in FIGS. 21 and 21A) may be referred to as a “floating shuttle” type locking assembly 460 structured in accordance with another embodiment of the invention.

Similar to other embodiments discussed above, the security device 400 comprises a housing 420 and a cable 440. The cable 440 defines a removable end 442 and a captured or anchor end 446. Additionally, in some embodiments, the security device 400 comprises a locking plate 470 (e.g., locking feature). However, as noted herein, the locking plate 470 may be replaced with at least one locking pin, similar to those embodiments described with respect to FIGS. 2A and 13A for security devices 10 and 100, respectively.

The housing 420 may comprise an annular lock housing 452 disposed within the housing 420. The lock housing 452 may be configured to receive the removable end 442 of the cable 440 within an annular cavity defined by the lock housing 452 (e.g., the cable is shown disposed within the lock housing in FIG. 21). As such, the housing 420 may be configured to removably receive the cable 440 in a first direction (e.g., along arrow T shown in FIG. 21).

Similar to previously described embodiments, the security device 400 may comprise a securing member. For example, the security device 400 may comprise an annular shuttle (e.g., driven element 462). The driven element 462, similar to the lock housing 452, may be annular so as to define a center cavity for receiving the cable 440 (e.g., the removable end 442 of the cable 440) there through. In the depicted embodiment, the center cavity of the driven element 462 aligns with the cavity of the lock housing 452 so as to receive the removable end of the cable therein upon insertion.

In some embodiments, the driven element 462 may comprise a first section 462 and a second section 462′. In the depicted embodiment, the driven element 462 comprises one integral section with portions of the driven element 462 connecting the first section 462 and second section 462′ being omitted from FIGS. 21-21A due to the nature of the partially sectioned view.

The securing member may be configured to secure the cable to prevent removal of the cable from the housing. For example, the driven element 462 may comprise at least two slots 472, 472′ defined in the driven element 462 for receiving at least one ball bearing 467, 467′ (e.g., two, three, four, etc.). The slots 472 are configured such that the ball bearing(s) 467, 467′ can move radially within the slots 472, 472′ toward and away from the cable 440. Outward lateral movement of the driven element 462 and the ball bearings 467, 467′ is constrained by the lock housing 452.

The securing member may also be configured to translate in a slide direction between a capture position and a release position. In some embodiments, the securing member may be configured to be driven from the release position to the capture position, such as by a user. For example, in some embodiments, the at least two ball bearings 467, 467′ are configured to pinch the cable to prevent removal of the cable when disposed in the capture position. In the depicted embodiment, the driven element 462 may translate between first and second springs 465, 415. As the driven element 462 translates toward the lock housing 452, the ball bearings 467, 467′ engage a contour (e.g., shoulder 453) of the lock housing 452 to each be driven inwardly. The inward radial translation causes each ball bearing to move along a slide direction (e.g., along arrow U shown in FIG. 21A) from a release position to a capture position. In some embodiments, the inward radial translation of the ball bearings 467, 467′ causes the ball bearings 467, 467′, which may be opposite each other with respect to the cable, to pinch the cable 440 firmly thereby locking the cable 440 in place when disposed in the capture position (shown in FIG. 21A). Upward translation of the driven element 462 forces upward against the biasing force S₁ of the first spring 465. With the cable 440 secure, the cable length may define a cable loop length (e.g., the length of the cable outside the housing forming a loop). In some embodiments, the object meant to be secured can be at least partially disposed inside this loop. Along these lines, embodiments of the present invention provide for a security device with an adjustable cable loop length so that different types of objects may be secured. As such, in some embodiments, the securing member may be configured to secure the cable at a different engagement position (e.g., a second engagement position) such that the cable defines a different cable loop length (e.g., a second cable loop length).

As such, with reference to FIG. 21A, the slide direction (e.g., along arrow U) may form a capture angle V relative to the first direction of the cable (e.g., along arrow T). In the depicted embodiment, the capture angle V defines approximately a 90° angle. In some embodiments, the capture angle may define a different angle (e.g., any angle from approximately 30° to approximately 150°).

The driven element 462 and the ball bearings 467, 467′ are configured to collectively “float” between two springs (i.e., the first spring 465 and the second spring 415). In one embodiment, the first and second springs 465, 415 are helical compression springs as shown. The first spring 465 is supported by tab 468 so as to provide a biasing force S₁ to driven element 462. The second spring 415 is configured between the slide 450 and the driven element 462 such that when a slide force F is applied by a user a biasing force S₂ is applied to the driven element 462. In the depicted embodiment, the driven element 462 and the slide 450 each define opposing cavities for receiving and supporting opposite ends of the second spring 415 as shown. In some embodiments, the appropriate springs 465, 415 may be chosen such that the biasing force S₁ of the first spring 465 is greater than the biasing force S₂ of the second spring 415. As such, in some embodiments, the first spring may be biased to force the shuttle (and thus the ball bearings) toward the release position and the second spring may be biased to force the shuttle (and thus the ball bearings) toward the capture position, and the first spring may have a greater biasing force than the second spring.

The security device may comprise a cam and/or slide configured to slidably engage the securing member to force the securing member to the capture position. In some embodiments, movement of the slide by the user operates to drive the opposing first and second securing members (e.g., ball bearings) from the release position to the capture position. Additionally, in some embodiments, the slide may be configured to engage the opposing first and second securing members to drive the opposing first and second securing members from the release position to the capture position. For example, the security device 400 comprises a slide 450. The slide 450 defines a grip 455 configured to allow a user to move the slide 450 to engage the securing member. The depicted slide 450 is cylindrical with a hollow annular wall that surrounds the cable 440 and supports/engages the second spring 415 as discussed above. Though the above description details a collective capture position and release position for both securing members, a similar first and second capture position and first and second release position may also be referred to herein.

In one embodiment, as the slide 450 is moved from a first position to a second position along arrow F, the slide 450 compresses the second spring 415, which applies an increasing biasing force S₂ to the driven element 462. The driven element 462 in turn is pressed upwardly into the ball bearings 467, 467′, which are each driven inwardly as they translate upwardly by the contour of the shoulder 453. As noted above, this inward radial translation of the ball bearings 467, 467′ cause the ball bearings 467, 467′ to pinch the cable 440 firmly thereby locking the cable 440 in place. Upward translation of the driven element 462 forces upward against the biasing force S₁ of the first spring 465. As used herein, and as is consistent with the above example embodiments, the user may not necessarily directly drive the securing member toward the capture position and may indirectly drive the securing member by directly moving and/or driving the slide.

The security device may define a locked position when movement of the cam (e.g., slide 450) is prevented and an unlocked position when movement of the cam is not prevented. For example, in some embodiments, the slide 450 defines one or more cavities or receiving features 456 that are adapted to slidably receive one or more spring biased locking members 476 extending from the locking plate 470 as discussed in greater detail below. When the security device 400 is in an unlocked position with no slide force F being applied by a user, both of the first and second springs 465, 415 are configured to position the driven element 462 and the ball bearings 467, 467′ such that the ball bearings 467, 467′ are located immediately below a compression shoulder 453 defined by the lock housing 452 (e.g., such that the ball bearings are disposed in the release position).

As will be apparent to one of ordinary skill in the art in view of this disclosure, the upward movement of the slide 450, the second spring 415, the driven element 462, and the ball bearings 467, 467′ continue until the one or more cavities or receiving features 456 defined by the slide 450 are captured by the one or more spring biased locking members 476 extending from the locking plate 470. At such point, the locking assembly is disposed in a locked position as shown in FIG. 21A. In this regard, the slide 450 is prevented from moving in a direction opposite to arrow F by the locking plate 470 and the cable 440 is locked against unauthorized removal by the pinching force applied by ball bearings 467, 467′.

In one embodiment, the first spring 465 is not fully compressed when the locking assembly 460 is disposed in the locked position. Accordingly, would be thieves who attempt to pull the cable 440 from the locking assembly 460 along a removal direction W actually operate to lock the cable 440 even more tightly in place. For example, if the cable 440 is pulled even slightly upwardly, the friction and pinching force present between the cable 440 and the ball bearings 467, 467′ causes the ball bearings 467, 467′ also to move upwardly. As a result, the ball bearings 467, 467′ are driven by the counter of the shoulder 453 to apply an even greater pinching force to the cable 440.

To unlock the security device 400 according to one embodiment, a magnetic key (not shown), similar to the magnetic key 181 in FIGS. 15-16, is used. The magnetic key may comprise one or more locating tabs (not shown) that correspond to locating features 480 defined in the housing 420. Thus, to unlock the security device 400, the magnetic key can be positioned with its locating tabs proximate the locating features 480 of the housing 420 thereby properly positioning the magnetic field produced by the magnet(s) of the magnetic key proximate the locking members 476 of the locking plate 470. In one embodiment, the magnetic field retracts the locking members 476 (e.g., in embodiments where the locking members 476 comprise a ferrous material) from the receiving members 456 of the slide 450 thus allowing the slide 450 to unlock. With the slide 450 unlocked, the first and second springs 465, 415 are free to expand to a relatively uncompressed state, thus, returning the driven element 462, the ball bearings 467, 1467′, and the slide 450 to their respective unlocked positions. As the ball bearings 467, 467′ move downwardly, the widening contour of the shoulder 453 allows them to move radially outwardly thereby alleviating any pinching force that was applied to the cable 440 in the locked position. In this regard, the cable 440 is thereby freed for removal by a user.

In another embodiment of a similar security device, such as security device 1400, shown in FIG. 21B, the driven element 1462 may comprise an angled surface 1463 which may counter the shoulder 1453 so as to force inward radial translation of the driven element 1462 to pinch the cable 1440 as the driven element 1462 is translated upward by the slide 1450 and second spring 1415. In the depicted embodiment, the ball bearings 1467, 1467′ are replaced with a crimp feature 1473 positioned at least partially facing and surrounding the cable 1440 so as to pinch or crimp the cable 1440 upon upward translation and corresponding inward radial translation of the driven element 1462. In some embodiments, the crimp feature 1473 may define an annular cavity for receiving the cable therein. As such, the crimp feature 1473 may define at least one slot (not shown), such as near the top of the crimp feature 1473 that allows the crimp feature 1473 to pinch radially inward upon upward translation. For example, the crimp feature may include space (e.g., from the slot) such that the portions of the crimp feature on either side of the slot may contract into the space as the crimp feature moves radially inward. In other embodiments, the crimp feature may define at least two separate crimp features that oppositely surround the cable and pinch inward upon upward translation. Other embodiments may comprise ball bearings 1467, 1476′ and a crimp feature 1473.

### Pressing Feature Embodiments

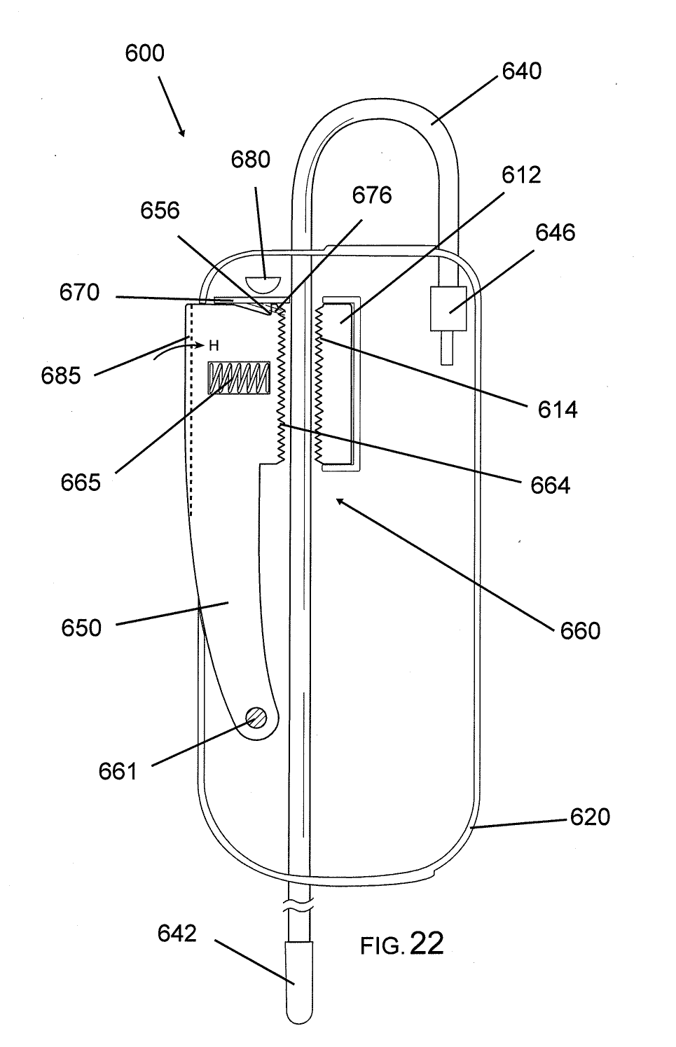

FIGS. 22-25 illustrate security devices having locking assemblies that respond to pressing features. Similar to other embodiments discussed above, each of the depicted security devices 600, 700, 800, 900 comprise a housing 620, 720, 820, 920 and a cable 640, 740, 840, 940. The cables 640, 740, 840, 940 define a removable end 642, 742, 842, 942 and a captured or anchor end 646, 746, 846, 946. Embodiments of the present invention described with respect to FIGS. 22-25 are shown with a locking plate 670, 770, 870, 970. However, the locking plate 670, 770, 870, 970 may be replaced with at least one locking pin, similar to those embodiments described with respect to FIGS. 2A and 13A for security devices 10 and 100, respectively.

FIG. 22 shows another example embodiment of a security device configured for secure attachment to an object. In particular, FIG. 22 depicts a security device 600 having a pressing feature and cam type locking assembly 660 structured in accordance with another embodiment of the invention. The depicted locking assembly 660 comprises a slide 650, a stationary lock 612, and a locking plate 670.

The slide 650 is biased in an unclamped position by a spring 665 that is supported by a flange tab (not shown) extending from the housing 620. The slide 650 comprises at least one clamp feature 664 configured to engage the cable 640 when the slide 650 is disposed in a clamped position to prevent movement of the cable 640. The slide 650 defines a pressing feature 685 configured to allow a user to press the slide 650 between a clamped position (e.g., capture position) and an unclamped position (e.g., release position).

The stationary lock 612 positionally opposes the clamping feature 664 of the slide 650 and may comprise at least one stationary clamping feature 614 to engage the cable 640 when the slide 650 is in the clamped position. In other embodiments, the security device 600 may not include a stationary lock 612.

In one embodiment, when a user presses the pressing feature 685, the slide 650 and the clamping feature 664 rotate around a pivot point 661, along line H, against the bias of the spring 665 from an unclamped position toward the cable 640 to a clamped position. As discussed above in connection with other embodiments, the slide 650 defines one or more cavities or receiving features 656 that are adapted to slidably receive one or more spring biased locking members 676 extending from the locking plate 670. In the depicted embodiment, the locking member 676 of the locking plate 670 snaps into the receiving feature 656 of the slide 650 once the slide 650 has rotated sufficiently to engage the clamping feature 664 with the cable 640, which corresponds to the clamped position of the slide 650. In this regard, the slide 650 is prevented from moving in a direction opposite to arrow H and the security device 600 is locked in a locked position.

To unlock the security device 600 according to one embodiment, a magnetic key (not shown), similar to the magnetic key 181 in FIGS. 15-16, is used. The magnetic key may comprise one or more locating tabs (not shown) that correspond to locating features 680 defined in the housing 620. Thus, to unlock the security device 600, the magnetic key can be positioned with its locating tab proximate the locating feature 680 of the housing 620 thereby properly positioning the magnetic field produced by the magnet(s) of the magnetic key proximate the locking member 676 of the locking plate 670. In one embodiment, the magnetic field retracts the locking member 676 from the receiving member 656 of the slide 650 thus allowing the slide 650 to be returned to an unlocked and unclamped position.

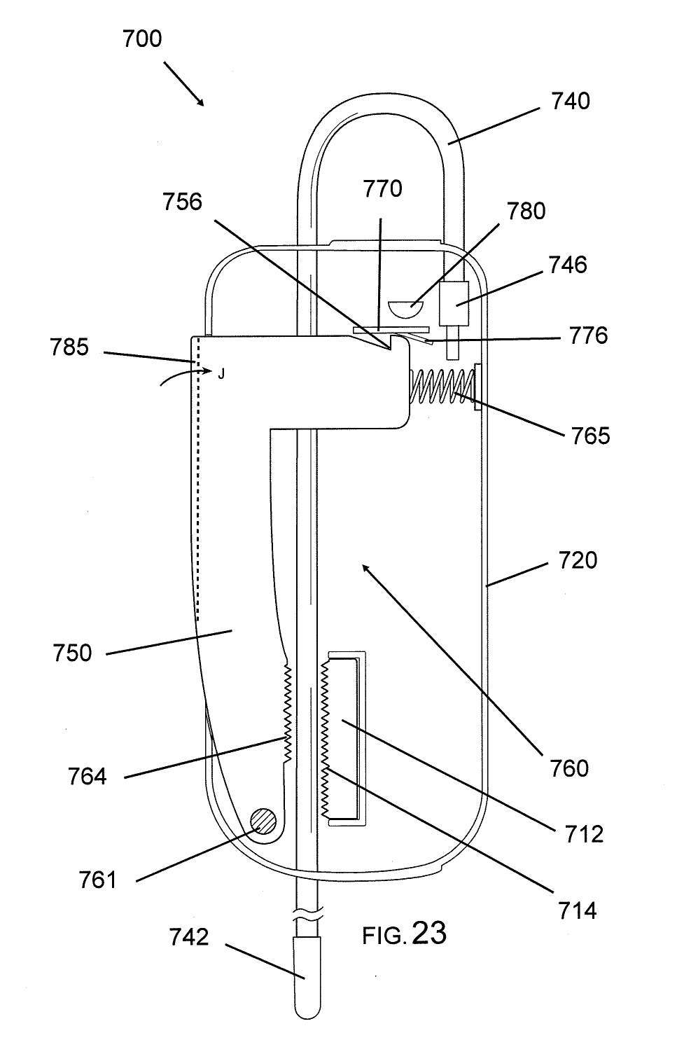

FIG. 23 depicts a security device 700 having a pressing feature and cam type locking assembly 760 structured in accordance with another embodiment of the invention. The depicted locking assembly 760 comprises a slide 750, a stationary lock 712, and a locking plate 770.

The slide 750 is biased in an unclamped position (e.g., release position) by a spring 765 that is supported against a wall of the housing 720. The slide 750 comprises at least one clamp feature 764 configured to engage the cable 740 when the slide 750 is disposed in a clamped position (e.g., capture position) to prevent movement of the cable 740. The slide 750 defines a pressing feature 785 configured to allow a user to press the slide 750 between the clamped position and the unclamped position.

The stationary lock 712 positionally opposes the clamping feature 764 of the slide 750 and may comprise at least one stationary clamping feature 714 to engage the cable 740 when the slide 750 is in the clamped position. In other embodiments, the security device 700 may not include a stationary lock 712.

In one embodiment, when a user presses the pressing feature 785, the slide 750 and the clamping feature 764 rotate around a pivot point 761, along line J, against the bias of the spring 765 from an unclamped position toward the cable 740 to a clamped position. As discussed above in connection with other embodiments, the slide 750 also defines one or more cavities or receiving features 756 that are adapted to slidably receive one or more spring biased locking members 776 extending from the locking plate 770. In the depicted embodiment, the locking member 776 of the locking plate 770 snaps into the receiving feature 756 of the slide 750 once the slide 750 has rotated sufficiently to engage the clamping feature 764 with the cable 740, which corresponds to the clamped position of the slide 750. In this regard, the slide 750 is prevented from moving in a direction opposite to arrow J and the security device 700 is locked in a locked position.

To unlock the security device 700 according to one embodiment, a magnetic key (not shown), similar to the magnetic key 181 in FIGS. 15-16, is used. The magnetic key may comprise one or more locating tabs (not shown) that correspond to locating features 780 defined in the housing 720. Thus, to unlock the security device 700, the magnetic key can be positioned with its locating tab proximate the locating feature 780 of the housing 720 thereby properly positioning the magnetic field produced by the magnet(s) of the magnetic key proximate the locking member 776 of the locking plate 770. In one embodiment, the magnetic field retracts the locking member 776 from the receiving member 756 of the slide 750 thus allowing the slide 750 to be returned to an unlocked and unclamped position.

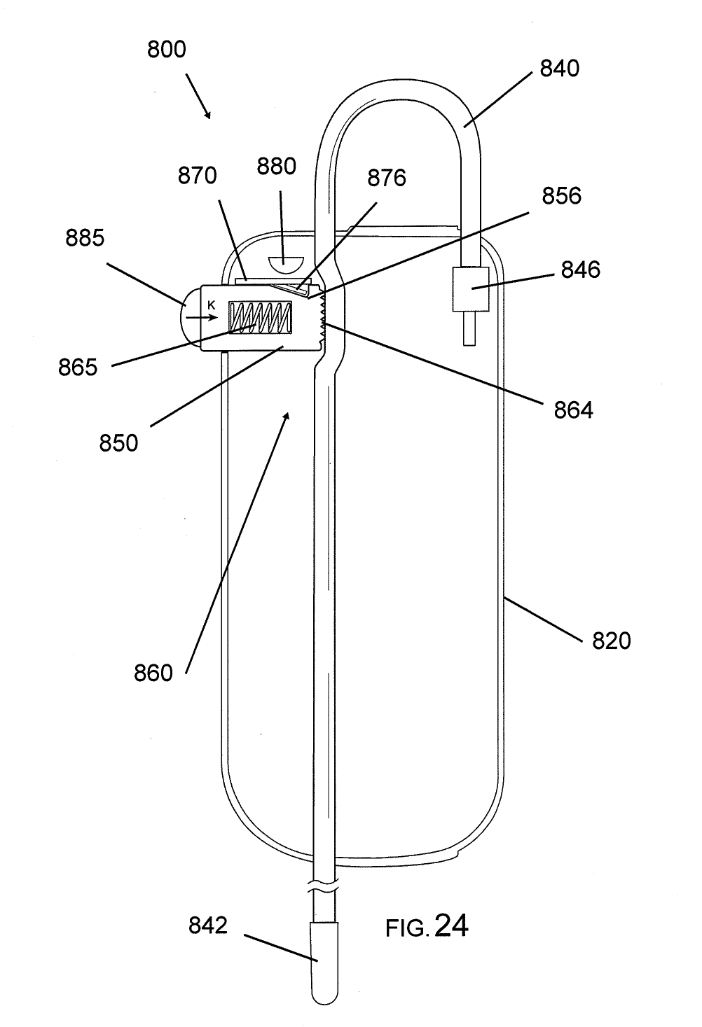

FIG. 24 depicts a security device 800 having a pressing feature and slide type locking assembly 860 structured in accordance with another embodiment of the invention. The depicted locking assembly 860 comprises a slide 850 and a locking plate 870.

The slide 850 is biased in an unclamped position by a spring 865 that is supported by a flange tab (not shown) extending from the housing 820. The slide 850 comprises at least one clamp feature 864 configured to engage the cable 840 when the slide 850 is disposed in a clamped position to prevent movement of the cable 840. The slide 850 defines a pressing feature 885 configured to allow a user to move the slide 850 between the unclamped position (e.g., release position) and a clamped position (e.g., capture position).

In one embodiment, pressing the pressing feature 885 forces the slide 850 against the bias of the spring 865, along line K, from an unclamped position to a clamped position. As discussed above in connection with other embodiments, the slide 850 defines one or more cavities or receiving features 856 that are adapted to slidably receive one or more spring biased locking members 876 extending from the locking plate 870. In the depicted embodiment, the locking member 876 of the locking plate 870 snaps into the receiving feature 856 of the slide 850 once the slide 850 has moved sufficiently to force the clamping feature 864 to securely engage the cable 840, which corresponds to a clamped position. In this regard, the slide 850 is prevented from moving in a direction opposite to arrow K and the security device 800 is locked in a locked position.

To unlock the security device 800 according to one embodiment, a magnetic key (not shown), similar to the magnetic key 181 in FIGS. 15-16, is used. The magnetic key may comprise one or more locating tabs (not shown) that correspond to the locating feature 880 defined in the housing 820. Thus, to unlock the security device 800, the magnetic key can be positioned with its locating tab proximate the locating feature 880 of the housing 820 thereby properly positioning the magnetic field produced by the magnet(s) of the magnetic key proximate the locking member 876 of the locking plate 870. In one embodiment, the magnetic field retracts the locking member 876 from the receiving member 856 of the slide 850 thus allowing the slide 850 to be returned to an unlocked and unclamped position.

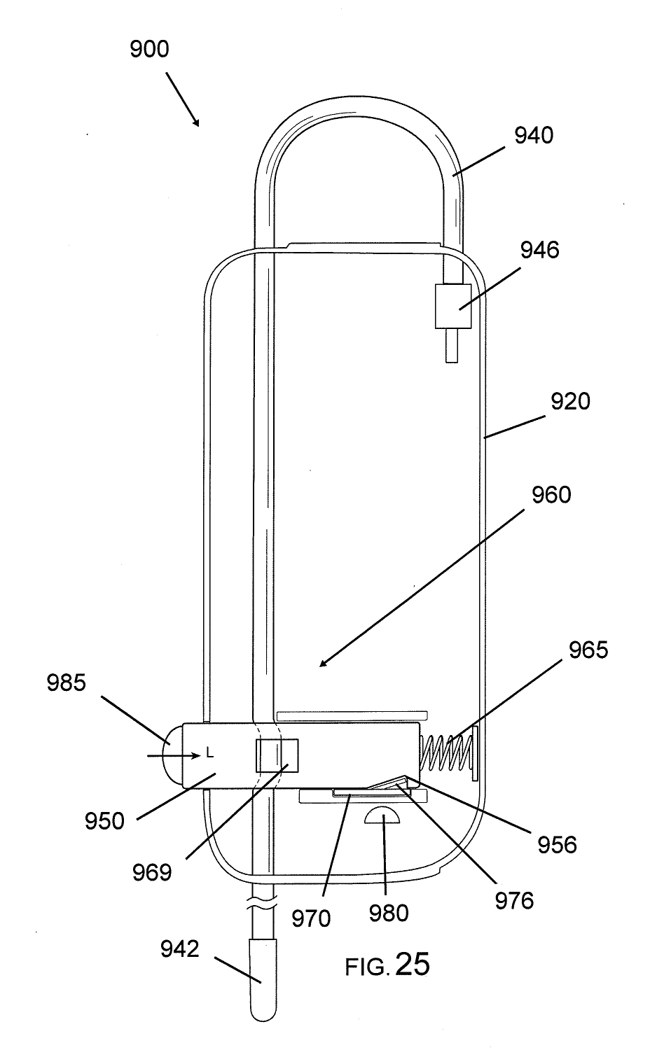

FIG. 25 depicts a security device 900 having a pressing feature and slide type locking assembly 960 structured in accordance with another embodiment of the invention. The depicted locking assembly 960 comprises a slide 950 and a locking plate 970.

The slide 950 is biased in an unclamped position by a spring 965 that is supported by the walls of the housing 920. The slide 950 comprises a slot 969 configured to receive the cable 940 and displace or kink a portion of the cable 940, when the slide 950 is disposed in the clamped position, to prevent movement of the cable 940. The slide 950 defines a pressing feature 985 configured to allow a user to move the slide 950 between the unclamped position (e.g., release position) and the clamped position (e.g., capture position).

In one embodiment, pressing the pressing feature 985 forces the slide 950 against the bias of the spring 965, along line L, from an unclamped position to a clamped position. As discussed above in connection with other embodiments, the slide 950 further defines one or more cavities or receiving features 956 that are adapted to slidably receive one or more spring biased locking members 976 extending from the locking plate 970. In the depicted embodiment, the locking member 976 of the locking plate 970 snaps into the receiving feature 956 of the slide 950 once the slide 950 has moved sufficiently for the slot 969 to displace or kink a portion of the cable 940 to secure the cable 940. In this regard, the slide 950 is prevented from moving in a direction opposite to arrow L and the security device 900 is locked in a locked position.

To unlock the security device 900 according to one embodiment, a magnetic key (not shown), similar to the magnetic key 181 in FIGS. 15-16, is used. The magnetic key may comprise one or more locating tabs (not shown) that correspond to the locating feature 980 defined in the housing 920. Thus, to unlock the security device 900, the magnetic key can be positioned with its locating tab proximate the locating feature 980 of the housing 920 thereby properly positioning the magnetic field produced by the magnet(s) of the magnetic key proximate the locking member 976 of the locking plate 970. In one embodiment, the magnetic field retracts the locking member 976 from the receiving member 956 of the slide 950 thus allowing the slide 950 to be returned to an unlocked and unclamped position.

In one or more of the embodiments discussed above, the security device may further include anti-theft features configured to provide one or more alerts in the event the security device is bypassed or object being secured is moved out of a specified area. For example, the anti-theft features may provide one or more of the following alerts: (1) activation of an alarm (audible and/or visual) at the location of a security gate (i.e., a gate alarm) when the object with the security device is physically moved through the security gate; (2) activation of an alarm (audible and/or visual) actually located inside or on the security device which is attached to the object when the object is physically moved through the security gate; and (3) activation of an alarm (audible and/or visual) in the security device when an attempt has been made to tamper with or bypass the locking mechanism (i.e., either the cable or the lock) of the security device. Details regarding methods and devices for providing such three alarm security are described in U.S. Publication No. 2006/0145848 entitled “Electronic Security Device and System for Articles of Merchandise,” U.S. Pat. No. 7,474,209 entitled “Cable Alarm Security Device,” and U.S. Pat. No. 7,497,101 entitled “Cable Wrap Security Device,” the contents of each of which are incorporated by reference herein.

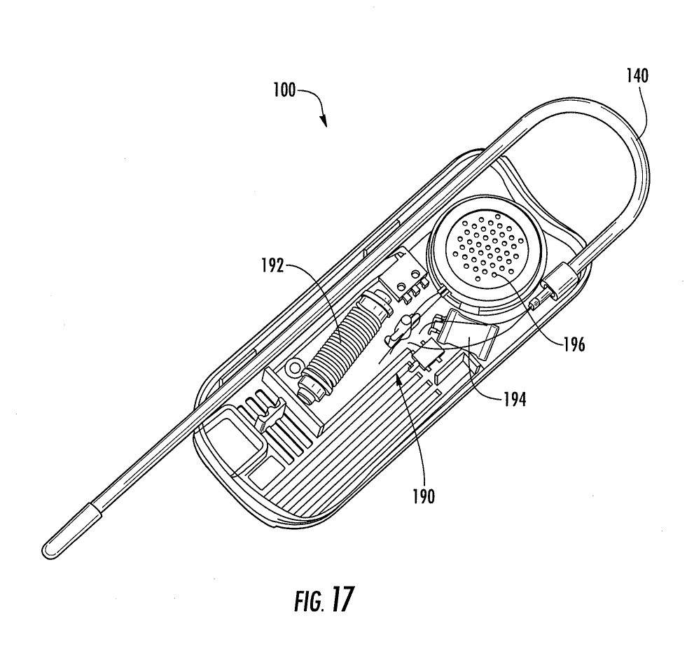

With reference to FIGS. 8 and 17, a security device 10, 100 (which may be any one of the security devices described above) is shown as having a housing 20, 120 that includes a security element 90, 190 inside the housing 20, 120. The security element, 90, 190 may be one of any number of devices that is configured to be detected by a security system such as an RFID transponder (e.g., an active tag, a passive tag, etc.) or an Electronic Article Surveillance (EAS) element. Considering the example of an EAS security element 92, 192, shown in FIGS. 8 and 17, the EAS element may be configured to be detectable when the EAS element is present in a predetermined detection zone, such as a zone set up at or near the door or other entrance point of a warehouse or distribution center. The EAS element may be configured to work within an EAS security system. For example, the EAS element may include a magnetic tag, such as those used in an electromagnetic (EM) system or in an acousto-magnetic (AM) system. As another example, the EAS element may be configured to work within a microwave system.

Referring to FIGS. 8 and 17, in some cases, the housing 20, 120 may include other security or alarm features. For example, the housing 20, 120 may have an audible alarm device, such as a piezoelectric speaker 196, which may be triggered in response to one or more circumstances. In some embodiments, the housing 20, 120 may thus include a printed circuit board with a logic circuit 94, 194, a sense loop configured to detect a fault condition associated with the security device 10, 100 (i.e., tampering with or bypassing the security device), and/or an energy source, such as a battery. The logic circuit may be disposed in communication with at least a portion of the security device 10, 100 described in various embodiments above to form a sense loop configured to detect a fault condition associated with the security device 10, 100. In this way, any discontinuity (e.g., cutting of the cable 40, 140 or unexpected movement of the locking assembly 60, 160) in the sense loop may be recognized as a fault condition, which triggers alarm functionality as described in greater detail below.

Thus, according to the embodiments shown in FIGS. 8 and 17, the housing 20, 120 may include components that provide 1-alarm (e.g., alarming by a security gate at the security gate when the object is improperly moved past the gate), 2-alarm (e.g., alarming at the security gate when the object is moved and alarming by the security device attached to the object when the security device is tampered with or compromised), or 3-alarm (e.g., alarming at the security gate when the object is moved and alarming by the security device attached to the object when the security device is tampered with or compromised and alarming by the security device attached to the object when the object is improperly moved past the security gate) functionality to the security device and attached object.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included herein. Although specific terms are employed herein, they are used in a generic and descriptive sense only and not for purposes of limitation.

1-50. (canceled)

51. A security device for secure attachment to an object, the security device comprising:
a cable defining an anchor end, a removable end, and a cable length therebetween;
a housing configured to removably receive the removable end of the cable and securely support the anchor end of the cable, wherein the housing defines a cavity structured to receive the removable end of the cable along a first direction; and
a securing member supported by the housing that is drivable by a user from a release position along a slide direction to a capture position, wherein the cable is secured within the cavity in the capture position and releasable from the cavity in the release position.

52. The security device according to claim 51, wherein the securing member is biased toward the release position, wherein the security device further comprises a cam configured to slidably engage the securing member, and wherein the user moves the cam against the securing member to drive the securing member against the bias and toward the capture position.

53. The security device according to claim 52 further comprising a locking feature configured to engage the cam to prevent movement of the cam in a locked position and to allow movement of the cam in an unlocked position.

54. The security device according to claim 53, wherein the locking feature is biased toward the locked position.

55. The security device according to claim 53, wherein at least a portion of the locking feature comprises a ferrous material, and wherein the locking feature is configured to be moved to the unlocked position upon application of a magnetic field.

56. The security device according to claim 51, wherein the securing member is drivable by the user to engage the cable at a first engagement position along the cable length, thereby defining a first cable loop length, or a second engagement position along the cable length, thereby defining a second cable loop length that is larger than the first cable loop length.

57. The security device according to claim 51 further comprising a capture angle defined between the first direction and the slide direction, wherein the capture angle is between approximately 30 degrees and approximately 150 degrees.

58. The security device according to claim 57, wherein the capture angle is approximately 90 degrees.

59. The security device according to claim 51, wherein the securing member is drivable by the user inserting the removable end of the cable into the cavity.

60. The security device according to claim 51 further comprising a security element.

61. The security device according to claim 60, wherein the security element comprises at least an EAS element, an audible alarm device, and a sense loop configured to detect a fault condition associated with the security device.

62. A security device for secure attachment to an object, the security device comprising:
a cable defining an anchor end, a removable end, and a cable length therebetween;
a housing configured to secure the anchor end of the cable and configured to removably receive the removable end of the cable, wherein the housing defines a cavity structured to receive the removable end of the cable along a first direction; and
a securing member supported by the housing that is drivable by a user from a release position along a slide direction to a capture position, wherein the cable is secured within the cavity by the securing member in the capture position and releasable from the cavity in the release position, wherein the securing member may engage the cable in the capture position, depending on the position of the cable, at a first engagement position along the cable length, thereby defining a first cable loop length, or a second engagement position along the cable length, thereby defining a second cable loop length that is larger than the first cable loop length, wherein a capture angle is defined between the first direction and the slide direction, and wherein the capture angle is between approximately 30 degrees and approximately 150 degrees.

63. The security device according to claim 62, wherein the capture angle is approximately 90 degrees.

64. The security device according to claim 62, wherein the securing member is biased toward the release position, wherein the security device further comprises a cam configured to slidably engage the securing member, and wherein the user moves the cam against the securing member to drive the securing member against the bias and toward the capture position.

65. The security device according to claim 64 further comprising a locking feature configured to engage the cam to prevent movement of the cam when the securing member is disposed in the capture position.

66. A security device for secure attachment to an object, the security device comprising:
a cable defining an anchor end, a removable end, and a cable length therebetween;
a housing configured to secure the anchor end of the cable and configured to removably receive the removable end of the cable, wherein the housing defines a cavity structured to receive the removable end of the cable along a first direction; and
a securing member supported by the housing that is drivable by a user from a release position to a capture position, wherein the cable is secured within the cavity by the securing member in the capture position and releasable from the cavity in the release position.

67. The security device according to claim 66, wherein the securing member is drivable by the user to engage the cable at a first engagement position along the cable length, thereby defining a first cable loop length, or a second engagement position along the cable length, thereby defining a second cable loop length that is larger than the first cable loop length.

68. The security device according to claim 66, wherein the securing member is drivable by the user from the release position along a slide direction to the capture position, wherein a capture angle is defined between the first direction and the slide direction, and wherein the capture angle is between approximately 30 degrees and approximately 150 degrees.

69. The security device according to claim 68, wherein the capture angle is approximately 90 degrees.

70. The security device according to claim 66, wherein the securing member is biased toward the release position, wherein the security device further comprises a cam configured to slidably engage the securing member, and wherein the user moves the cam against the securing member to drive the securing member against the bias and toward the capture position.

71. The security device according to claim 70 further comprising a locking feature configured to engage the cam to prevent movement of the cam when the securing member is disposed in the capture position.

72. The security device according to claim 70, wherein the cam defines a grip protruding through the housing and configured for engagement by the user to move the cam.

73. The security device according to claim 70, further comprising a second securing member that is drivable by the user from a second release position to a second capture position, wherein the cable is positioned between the second securing member and the securing member, and wherein the user moves the cam against the securing member and the second securing member to drive the securing member the second securing member to the capture position and the second capture position respectively.

74. The security device according to claim 66, wherein the securing member is rotatably supported within the housing, and wherein the securing member is driven by the user to rotate from the release position to the capture position.

75. The security device according to claim 66, wherein the securing member defines at least two teeth structured to crimp the cable when the securing member is disposed in the capture position.

76. The security device according to claim 66, wherein the housing defines first and second ends, and wherein the cavity is defined by the housing between the first and second ends such that the removable end of the cable may be inserted into the cavity proximate the first end and pass fully through the housing to at least partially protrude from the housing proximate the second end.

77. The security device according to claim 66 further comprising a security element.

78. The security device according to claim 77, wherein the security element comprises at least an EAS element, an audible alarm device, and a sense loop configured to detect a fault condition associated with the security device.
